(19) United States
(12) Patent Application Publication
(10) Pub. No.: US 2011/0208847 A1
(43) Pub. Date: Aug. 25, 2011

(54) ADDRESS REGISTRATION METHOD, ADDRESS REGISTRATION SYSTEM, MOBILE DEVICE AND MOBILE MANAGEMENT DEVICE

(75) Inventors: Chun Keong Benjamin Lim, Singapore (SG); Keigo Aso, Kangawa (JP); Chan Wah Ng, Singapore (SG); Mohana Dhamayanthi Jeyatharan, Singapore (SG)

(73) Assignee: PANASONIC CORPORATION, Osaka (JP)

(21) Appl. No.: 13/126,548

(22) PCT Filed: Nov. 9, 2009
(86) PCT No.: PCT/JP2009/005937

§ 371 Date: Apr. 28, 2011

(30) Foreign Application Priority Data
Nov. 11, 2008 (JP) 2008-288776

(51) Int. Cl. G06F 15/177

(52) U.S. Cl. 709/222

(57) ABSTRACT

Disclosed is a technique in which, when respective addresses of multiple interfaces of a mobile node are registered with a mobile management device, a delay in transmission of packets destined to addresses other than the source address of a bulk registration message is prevented. According to the technique, an MN 100 uses each of addresses associated with IFs 1000 and 1001 as a source address, respectively, to send a HA 101 an individual registration BU message S30, S31 for registering the source address individually. When receiving the individual registration BU message S30, S31, the HA 101 registers the source address as having been verified through ingress filtering of a foreign network domain 11, and sends a BA message S32, S33 to authorize bulk registration for updating the respective addresses in bulk.

### TECHNICAL FIELD

The present invention relates to an address registration method and an address registration system for registering each address of multiple interfaces of a mobile device with a mobile management device for managing the movement of the mobile device.

The present invention also relates to the mobile device and the mobile management device in the above-mentioned address registration system.

### BACKGROUND ART

According to mobile IPv6 (MIPv6) in Non-Patent Document 1 described below, a mobile node can maintain one IP address permanently even if the point-of-attachment to the Internet is changed. This permanent IP address in MIPv6 is an address of the mobile node in a home network domain, known as a home address. Further, when the mobile node is attached to a foreign network domain, the IP address used in the foreign network domain can be configured from a subnet prefix advertised by the foreign network domain. The configured IP address is known as a care-of address, and the care-of address can be used as the destination of the mobile node.

In order to maintain reachability irrespective of the location of the mobile node, the mobile node has a home agent as its mobile management device bind the current care-of address to the home address. In MIPv6, the home agent is a router for registering the care-of address of the mobile node in the home network domain of the mobile node. The mobile node sends to the home agent a binding update (BU) to perform such registration. While the mobile node is located away from the home network domain, the home agent intercepts packets destined to the home address of the mobile node and tunnels the intercepted packets to the care-of address of the mobile node. Since a host is involved in the mobility management in MIPv6, MIPv6 can be known as a host-based mobility management protocol.

In the meantime, when portable electronic peripheral equipment with multiple network interfaces integrated is introduced, the mobile node and the router can register multiple care-of addresses to one home address (e.g., Non-Patent Document 2 described below). In the method described in Non-Patent Document 2, identifier numbers called binding unique identifier (BID) numbers are used to make distinctions among multiple bindings to one home address. This BID is allocated to an interface or a care-of address bound to one home address of the mobile node and the router. Thus, the home address is associated with the mobile node and the router, while the BID identifies each of the multiple bindings registered by the mobile node at the same time. The mobile node and the router notify the home agent of the BID using a BU message, and the home agent records this BID in a binding cache.

FIG. 1 shows an assumed example of a system used for host-based mobility management. In FIG. 1, it is assumed that an MN 100 has two interfaces (IFs) 1000 and 1001 originally located in a home network domain 10 and has been communicating with a communication partner (CN: Correspondent Node) 300 using a home address (HoA). It is further assumed that the MN 100 moves outside the home network domain 10 and continues to communicate with the CN 300 using MIPv6 during roaming around a foreign network domain 11 across a global communication domain 12. Therefore, when roaming around the foreign network domain 11, the MN 100 has a HA 101 in the home network domain 10 binding the current care-of address (CoA) to the HoA.

It is further assumed that the MN 100 has the interface (IF) 1000 attached to a 3G cellular network 110 and the IF 1001 attached to a wireless local area network (WLAN) 111, and connects the IFs 1000 and 1001 at the same time in the foreign network domain 11. In this case, the MN 100 adopts Non-Patent Document 2 to bind an IP address (CoA1) configured for the IF 1000 and an IP address (CoA2) configured for the IF 1001 to the HoA at the HA 101.

Usually, the MN 100 sends the HA 101 each individual BU message to bind each of the IP addresses CoA1 and CoA2, respectively (hereinafter referred to as “individual registration BU message”). As a method of optimizing signaling between the MN 100 and the HA 101, Non-Patent Document 2 proposes that two or more individual registration BU messages are gathered into one BU message (hereinafter, bulk registration BU message). This technique is known as bulk registration and has the advantage of reducing the number of signaling messages between the MN 100 and the HA 101. The reduction in the number of signaling messages implies that the overhead of packets for the messages can be greatly reduced. For example, when the MN 100 sends one bulk registration BU message instead of two individual registration BU messages, the savings of the packet overhead can be up to 45 percent. The details of the saving of packet overhead are described in Non-Patent Document 3 described below.

Further, when this system is provided by a 3GPP operator, some sort of security measure is taken to protect networks from malicious activities. A possible security measure is ingress filtering as described in Non-Patent Document 4 described below. Using the ingress filtering, the network side can know that a specific packet is coming from an intended source. A gateway router in each network can check for the source IP address of the packet to ensure that it matches an IP address list handled by a specific router. If the source IP address of the packet does not exist in the IP address list, the gateway router will suspect that the packet is malicious, hence discarding the packet. Thus, with the gateway router in the foreign network domain 11 checking the source IP address of the packet using the ingress filtering, the HA 101 can be assured that the packet sent from the MN 100 in the foreign network domain 11 is true.

However, since only one of the multiple care-of addresses (CoAs) is described in the source address of a bulk registration BU message and the remaining care-of addresses are transmitted through an encrypted bulk registration BU message, the gateway router cannot check whether the remaining care-of addresses are valid. For example, the MN 100 sends a bulk registration BU message from the IF 1000 to the HA 101 on condition that the IF 1000 uses care-of address 3G.Addr and the IF 1001 uses care-of address WLAN.Addr to perform communication. Since the source address of the bulk registration BU message is the care-of address 3G.Addr, the HA 101 verifies the care-of address 3G.Addr through the ingress filtering of the foreign network domain 11.

On the other hand, the care-of address WLAN.Addr in the bulk registration BU message is transmitted in a mobility option to the HA 101. Therefore, since the ingress filtering by the foreign network domain 11 cannot make the HA 101 convinced that the care-of address WLAN.Addr is an IP address used in the foreign network domain 11, the HA 101 has to rely on a trust relationship established with the MN 100 and assume that the MN 100 is using the care-of address WLAN.Addr. For this scenario, the MN 100 maliciously makes improper use of the trusting relationship with the HA 101 to describe an IP address in the bulk registration BU message. If this IP address is being used by another mobile node, the MN 100 can instruct the HA 101 to forward packets to the IP address of the other mobile node. This means that the MN 100 can have the HA 101 forward a flood of meaningless packets to the victimized mobile node to make a redirection attack, resulting in congestion of packets sent from and received at the victimized mobile node under normal circumstances.

Therefore, the 3GPP operator may adopt another security measure to prevent malicious attacks through the bulk registration. A method easy for and obvious to the HA 101 is to verify each address (except the source address) described in the bulk registration BU message. In this case, the HA 101 can send an encrypted message to each address described in the bulk registration BU message to request the MN 100 to return a decrypted message. If the HA 101 can receive the decrypted message sent back from the MN 100, it means that the HA 101 can verify that the MN 100 is using each address described in the bulk registration BU message. The details of this method are shown in Non-Patent Document 5, Patent Document 1 and Patent Document 2 and Patent Document 3 described below.

Similarly, when the MN 100 has multiple interfaces, the HA 101 sends an encrypted message via one interface to request the MN 100 to return a decrypted message via another interface, thereby enabling optimization of the verification process. For example, suppose that the MN 100 sends, to the HA 101 from the IF 1000, the bulk registration BU message to register the care-of addresses 3G.Addr and WLAN.Addr with the HA 101 on condition that the IF 1000 uses the care-of address 3G.Addr and the IF 1001 uses the care-of address WLAN.Addr to perform communication. In this case, the HA 101 sends an encrypted message to the IF 1000 to request the MN 100 to return a decrypted message via the IF 1001 in order to verify the care-of address WLAN.Addr. The advantage of sending an encrypted message to the address (3G.Addr) already verified by the network (after being subjected to ingress filtering by the foreign network domain 11) is to prevent the HA 101 from sending packets to the unverified address (WLAN.Addr) to start a redirection attack deliberately. The details of this method are shown in Patent Document 4 described below.

In the above-mentioned prior art, since the HA 101 exchanges messages with the MN 100 to verify IP addresses other than the source address, there is a problem that the timing that the MN 100 uses any IP address other than the source address for the purpose of actual packet routing is delayed. For example, suppose that the MN 100 sends, to the HA 101 from the IF 1000 a bulk registration BU message to register the care-of addresses 3G.Addr and WLAN.Addr with the HA 101. The HA 101 sends an encrypted message to the IF 1000 to verify the care-of address WLAN.Addr on condition that the IF 1000 uses the care-of address 3G.Addr and the IF 1001 uses the care-of address WLAN.Addr. In this case, the HA 101 should not use the care-of address WLAN.Addr to forward packets to the MN 100 until a decrypted message is received by HA 101 from the MN 100. This enables the HA 101 to ensure that it does not make an unintended redirection attack. However, the above-mentioned method requires the HA 101 to spend time exchanging three messages to use the care-of address WLAN.Addr in order to forward packets to the MN 100.

As an obvious method to solve the above-mentioned delay problem, a proxy entity having a trusting relationship established with the HA 101 can register the IP addresses of the MN 100 with the HA 101. For example, the 3GPP operator of the home network domain 10 may exchange some service contract with the 3GPP operator of the foreign network domain 11. In such a service contract, a mutual trusting relationship is established between the HA 101 and a proxy entity (e.g., AAA (Authentication, Authorization and Accounting) server) of the foreign network domain 11. When the HA 101 establishes such a mutual trusting relationship, it trusts the IP addresses registered by the proxy entity for the MN 100. The details of this method are shown in Patent Document 5 and Patent Document 6 described below. Patent Document 7 also teaches that the proxy entity describes, in the packet header of a registration message, that IP addresses of the MN 100 described in the registration message destined to the HA 101 are true.

However, in the above-mentioned prior art, a third entity for verifying an IP address is introduced in the system to reduce the delay upon using the IP address for the purpose of packet forwarding. In addition, before using the conventional methods, it is necessary to establish some sort of trusting relationship between the home network domain 10 and the foreign network domain 11. However, it is difficult for all 3GPP operators to establish and maintain such a mutual trusting relationship.

As another obvious method to solve the above delay problem, there is a method by which the MN 100 uses an encryption technique to generate an IP address to be registered with the HA 101. The details of this method are shown in Non-Patent Document 6 described below. For this method, the MN 100 cannot bind the encrypted and generated IP address if it does not have the IP address. However, when using the encrypted and generated IP address, the MN 100 needs to run a complicated hash function in order to get the IP address.

Such complexity result in the MN 100 requiring more processing power to generate the IP address. In addition, the MN 100 needs to include, in the BU message destined to the HA 101, a parameter used in generating the IP address.

Note that this parameter is used by the HA 101 in verifying that the IP address is true. The addition of the parameter used in generating the IP address into the bulk registration BU message increases the message size. For example, Non-Patent Document 7 described below teaches that the size of each parameter option is limited to 255 bytes and one message will include two or more parameter options.

### PRIOR ART DOCUMENT

### Patent Document

Patent Document 1: P. Danny, T. Daniel C., and B. Richard, “Link discovery and verification procedure using loopback”, U.S. Pat. No. 6,834,139 B1, Dec. 21, 2004.

Patent Document 2: S. John A., “Methods and apparatus for determining, verifying, and rediscovering network IP addresses”, U.S. Pat. No. 6,195,706 B1, Feb. 27, 2001.

Patent Document 3: C. Josep, D. Scott N. and V. Theodore B., “Apparatus, system, and method for automatically verifying access to a mulitipathed target at boot time”, US Patent Application Publication No. 2007/0143583 A1, Jun. 21, 2007.

Patent Document 4: J. Hirano, B. Lim, C-W. Ng, B. Koh and P-Y. Tan, “Method and apparatus for address verification during multiple address registration”, WO Patent Application Publication No. 2008/023845 A1, Feb. 28, 2008.

Patent Document 5: K. Leung and G. Dommety, “Methods and apparatus for providing mobility of a node that does not support mobility”, U.S. Pat. No. 6,466,964 B1, Oct. 15, 2002.

Patent Document 6: H. Guan, J. Wang and Y. Huang, “Method and System for Authorizing and Charging Host with Multiple Addresses in IPv6 Network”, US Patent Application Publication No. 2007/0169180 A1, Jul. 19, 2007.

Patent Document 7: P-A. Son, “System and method for carrying trusted network provided access network information in session initiation protocol” US Patent Application Publication No. 2008/0039085 A1, Feb. 14, 2008.

### Non-patent Document

Non-Patent Document 1: D. Johnson, C. Perkins and J. Arkko, “Mobility Support in IPv6”, Internet Engineering Task Force Request For Comments 3775, June 2004.

Non-Patent Document 2: R. Wakikawa, T. Ernst and K. Nagami, “Multiple Care-of Addresses Registration”, draft-ietf-monami6-multiplecoa-00.txt, Jun. 12, 2006.

Non-Patent Document 3: M. Kuparinen, H. Mahkonen and T. Kauppinen, “Multiple CoA Performance Analysis”, draft-kuparinen-monami6-mcoa-performance-00.txt, Apr. 20, 2006.

Non-Patent Document 4: F. Baker and P. Savola, “Ingress Filtering for Multihomed Networks”, Internet Engineering Task Force Request For Comments 3704, March 2004.

Non-Patent Document 5: F. Dupont, and J-M. Combes, “Care-of Address Test for MIPv6 using a State Cookie”, draft-dupont-mipv6-rrcookie-00.txt, Jan. 10, 2005.

Non-Patent Document 6: T. Aura, “Cryptographically Generated Addresses (CGA)”, Internet Engineering Task Force Request For Comments 3972, March, 2005.

Non-Patent Document 7: J. Arkko, C. Vogt and W. Haddad, “Enhanced Route Optimization for Mobile IPv6”, Internet Engineering Task Force Request For Comments 4866, May, 2007.

As discussed above, when each of addresses associated with multiple interfaces of a mobile node is registered with a mobile management device for managing the movement of the mobile node, there is a problem that a delay occurs in transmission of packets destined to addresses other than the source address of a bulk registration message.

### SUMMARY OF THE INVENTION

The present invention has been made in view of the above-mentioned problem, and it is an object thereof to provide an address registration method, an address registration system, a mobile node and a mobile management device, which can prevent a delay in transmission of packets destined to addresses other than the source address of a bulk registration message when each of addresses associated with multiple interfaces of the mobile node is registered with the mobile management device for managing the movement of the mobile node.

In order to achieve the above object of the present invention, there is provided an address registration method for registering, with a mobile management device for a mobile node, a plurality of addresses allocated to a plurality of interfaces of the mobile node, the method comprising:

a first step in which the mobile node sends the mobile management device a plurality of individual registration messages for registering a source address individually while setting each of addresses associated with the plurality of interfaces as the source address;

a second step in which, when receiving the plurality of individual registration messages, the mobile management device registers the source address and sends the mobile node a response message to authorize bulk registration for updating the plurality of addresses in bulk; and

a third step in which, when the plurality of addresses are updated in bulk after receiving the response message, the mobile node uses one of the plurality of interfaces as a source to send the mobile management device a bulk registration message including addresses of the other interfaces somewhere other than a source address field.

In order to achieve the above object of the present invention, it is further provided an address registration system for registering, with a mobile management device for a mobile node, a plurality of addresses allocated to a plurality of interfaces of the mobile node, the system comprising:

first means for causing the mobile node to send the mobile management device a plurality of individual registration messages for registering a source address individually while setting each of addresses associated with the plurality of interfaces as the source address;

second means which, when the mobile management device receives the plurality of individual registration messages, causes the mobile management device to register the source address and send the mobile node a response message to authorize bulk registration for updating the plurality of addresses in bulk; and

third means which, when the plurality of addresses are updated in bulk after the mobile node receives the response message, causes the mobile node to use one of the plurality of interfaces as a source to send the mobile management device a bulk registration message including addresses of the other interfaces somewhere other than a source address field.

Further, in order to achieve the above object of the present invention, there is provided a mobile node in an address registration system for registering, with a mobile management device for the mobile node, a plurality of addresses allocated to a plurality of interfaces of the mobile node, the device comprising:

means for sending the mobile management device a plurality of individual registration messages to register a source address individually while setting each of addresses associated with the plurality of interfaces as the source address; and

means which, when the plurality of addresses are updated in bulk after receiving, from the mobile management device, a response message to authorize bulk registration for updating the plurality of addresses in bulk, uses one of the plurality of interfaces as a source to send the mobile management device a bulk registration message including addresses of the other interfaces somewhere other than a source address field.

Further, in order to achieve the above object of the present invention, there is provided a mobile management device in an address registration system for registering, with the mobile management device for a mobile node, a plurality of addresses allocated to a plurality of interfaces of the mobile node, the device comprising:

means which, when receiving, from the mobile node, a plurality of individual registration messages for registering a source address individually while setting each of addresses associated with the plurality of interfaces as the source address, registers the source address and sends the mobile node a response message to authorize bulk registration for updating the plurality of addresses in bulk; and

means which, after sending the response message, when receiving, from the mobile node using one of the plurality of interfaces as a source, a bulk registration message including addresses of the other interfaces somewhere other than a source address field, updates the plurality of addresses in bulk.

According to the above structures, when the plurality of addresses allocated to the plurality of interfaces of the mobile node are registered with the mobile management device for the first time, each address is authenticated using the individual registration message through ingress filtering of a network or the like, and after being registered, when the plurality of addresses are updated in bulk, a bulk registration message is used. Therefore, a delay in transmission of packets destined to addresses other than the source address of the bulk registration message can be prevented.

According to the present invention, when each of addresses associated with the plurality of interfaces of the mobile node is registered with the mobile management device for managing the movement of the mobile node, a delay in transmission of packets destined to addresses other than the source address of the bulk registration message can be prevented.

### BRIEF DESCRIPTION OF THE DRAWINGS

FIG. 1 It is a block diagram showing an assumed example of a system to which an address registration method of the present invention is applied.

FIG. 2 It is a block diagram functionally showing the structure of a mobile node according to a first embodiment of the present invention.

FIG. 3 It is a block diagram functionally showing the structure of a home agent according to the first embodiment of the present invention.

FIG. 4 It is an explanatory drawing showing a communication sequence in the first embodiment of the present invention.

FIG. 5 It is an explanatory drawing showing the format of a notification message of the first embodiment of the present invention.

FIG. 6 It is a flowchart for describing processing performed by a mobile node to judge the advisability of bulk registration in the first embodiment of the present invention.

FIG. 7 It is a flowchart for describing processing performed by the home agent to verify a bulk registration BU message in the first embodiment of the present invention.

FIG. 8 It is an explanatory drawing showing a communication sequence of a second embodiment of the present invention.

FIG. 9 It is an explanatory drawing showing the format of an individual registration BU message in the second embodiment of the present invention.

FIG. 10 It is a flowchart showing processing performed by the mobile node to judge the advisability of bulk registration in the second embodiment of the present invention.

FIG. 11 It is a flowchart for describing processing performed by the home agent to verify a bulk registration BU message in the second embodiment of the present invention.

FIG. 12 It is an explanatory drawing showing a communication sequence in a third embodiment of the present invention.

FIG. 13 It is an explanatory drawing showing the format of a bulk registration BU message in the third embodiment of the present invention.

FIG. 14 It is a flowchart showing processing performed by a proxy to assist in verification of an IP address in a bulk registration BU message in the third embodiment of the present invention.

FIG. 15 It is an explanatory drawing showing the format of a bulk registration BA message in a sixth embodiment of the present invention.

FIG. 16 It is a flowchart showing processing when the mobile node receives a bulk registration BA message in the sixth embodiment of the present invention.

FIG. 17 It is a block diagram showing an assumed example of a system in an eighth embodiment of the present invention.

FIG. 18 It is an explanatory drawing showing a message sequence in the eighth embodiment of the present invention.

FIG. 19 It is an explanatory drawing showing the format of an individual registration BA message in the eighth embodiment of the present invention.

FIG. 20 It is an explanatory drawing showing the format of an individual registration BU message in the eighth embodiment of the present invention.

### DESCRIPTION OF EMBODIMENTS

Embodiments of the present invention will now be described with reference to the accompanying drawings. In the following description, a specific number, time, configuration, protocol name and other parameters are described to help understand the present invention, and it will be apparent to those skilled in the art that the present invention can be carried out without being limited to these parameters. Further, the names indicated in block diagrams are used to avoid unnecessarily obscuring the present invention.

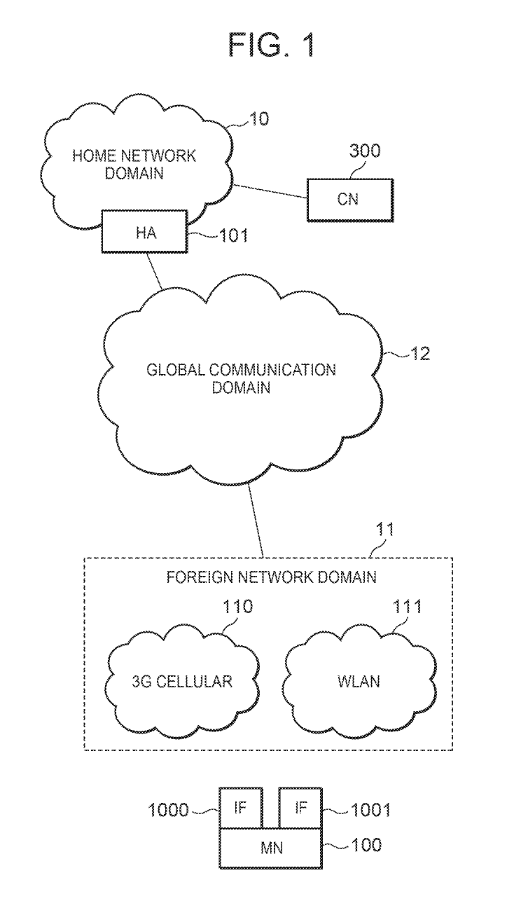

FIG. 1 shows an assumed example of a system used by an address registration method of the present invention. Since the schematic structure of the system in FIG. 1 is described in “Background Art,” the detailed description thereof will be omitted here. This system can be associated with SAE (System Architecture Evolution) being worked in 3GPP-LTE (Third Generation Partnership Project Long Term Evolution) project. Describing the relationship between this system and SAE, a home agent (HA) 101 can be associated with a packet data network gateway (PDN-GW) in SAE, and a mobile node (MN) 100 can be associated with user equipment (UE) in SAE in like fashion. A network 111 is a Non-3GPP network, which may be any access network such as WiMAX without being limited to WLAN.

In the present invention, the MN 100 having two interfaces (IFs) 1000 (3GPP interface) and 1001 (Non-3GPP interface) first sends to the HA 101 two or more individual registration BU messages to individually register source addresses as the source addresses of the IFs 1000 and 1001, respectively, in order to register, with the HA 101, IP addresses (care-of addresses: CoAs) allocated to the IFs 1000 and 1001 in a foreign network domain 11 and further update them. When receiving the two or more individual registration messages, the HA 101 registers the source address as having been verified through ingress filtering of the foreign network domain 11. The HA 101 sends the MN 100 a response message (BA message) including information indicating how the BU message should be sent to streamline the transmission of future BU messages from the MN 100. The information includes information (bulk pattern information) to indicate a transmission method for a bulk registration BU message so that the MN 100 will send subsequent BU messages according to the information.

<Structure of MN>

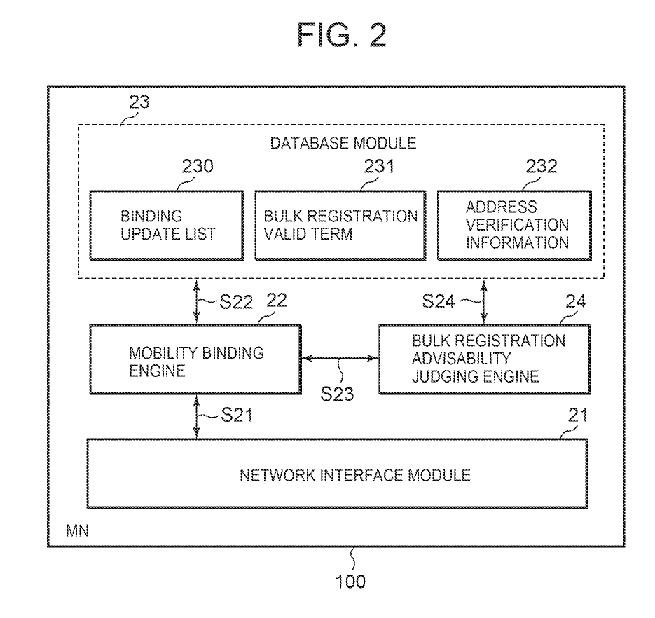

FIG. 2 is a block diagram functionally showing the structure of the MN 100. The structure shown in FIG. 2 can be applied to any node other than the MN 100 such as a mobile router. The MN 100 has a network interface module 21, a mobility binding engine 22, a database module 23 and a bulk registration advisability judging engine 24. The network interface module 21 is a functional block for executing a program and software necessary to communicate with another node through communication media. If a term in the related technical field is used, the network interface module 21 represents a communication component, firmware, driver and communication protocol of layer 1 (physical layer) and layer 2 (data link layer). It will be apparent to those skilled in the art that one or more network interface modules 21 are provided (e.g., IFs 1000 and 1001 in FIG. 1).

The network interface module 21 and the mobility binding engine 22 can mutually transmit trigger signals and packets through a signal/data path S21. For example, the network interface module 21 forwards a mobility signaling message received from another node (e.g., a BA message received from the HA 101) to the mobility binding engine 22 to cause the mobility binding engine 22 process it. Similarly, the mobility binding engine 22 forwards a mobility signaling message (e.g., a BU message) to the network interface module 21 to cause the network interface module 21 send it to another node (e.g., the HA 101).

The mobility binding engine 22 manages the mobility of the MN 100. If a term in the related technical field is used, the mobility binding engine 22 represents the function of a layer 3 (network layer) protocol such as MIPv4 or MIPv6 (Mobile Internet Protocol version 4 or 6). The mobility binding engine 22 and the database module 23 can mutually transmit trigger signals and packets through a signal/data path S22. For example, the mobility binding engine 22 updates information (e.g., care-of address) in the database module 23 or retrieves information from the database module 23 to execute the function of mobility management.

Similarly, the mobility binding engine 22 and the bulk registration advisability judging engine 24 can mutually transmit trigger signals and packets through a signal/data path S23. For example, the mobility binding engine 22 can trigger the bulk registration advisability judging engine 24 before refreshing the binding of an address of the MN 100 registered with the HA 101 to identify which address can be used for bulk registration.

The database module 23 accumulates information necessary for the MN 100. In this preferred embodiment, the database module 23 accumulates a binding update list 230, a bulk registration valid period 231 and address verification information 232. The binding update list 230 includes one or more entries for the current care-of addresses of the MN 100 registered with the destination node (e.g., the HA 101 or a CN 300). In addition, in a first embodiment, the bulk registration valid period 231 is introduced into one or plural care-of addresses used for bulk registration. The address verification information 232 includes data related to the bulk registration advisability judging engine 24 making a judgment (e.g., one or plural care-of addresses used for bulk registration, public key and private key).

In the present invention, the bulk registration advisability judging engine 24 is introduced to judge whether a specific care-of address is usable for bulk registration (i.e., whether bulk registration therefor is authorized by the HA 101). For example, the bulk registration advisability judging engine 24 aims to use the bulk registration valid period 231 in the database module 23 to judge whether a specific care-of address is available for bulk registration.

<Structure of HA>

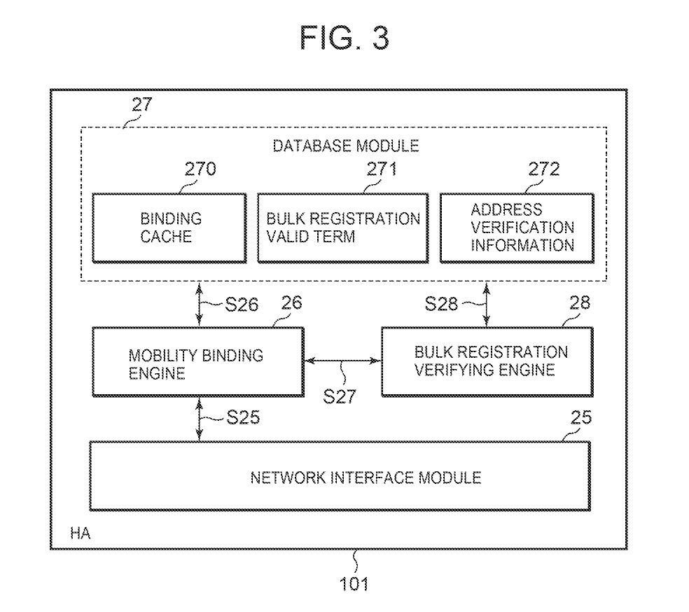

FIG. 3 is a block diagram functionally showing the structure of the HA 101. The structure shown in FIG. 3 can also be applied to any node other than the HA 101 such as the CN 300. The HA 101 has a network interface module 25, a mobility binding engine 26, a database module 27 and a bulk registration verifying engine 28. Like in FIG. 2, since the network interface module 25 is a functional block for executing a program and software necessary to communicate with another node through communication media, the detailed description thereof will be omitted. It will be apparent to those skilled in the art that one or more network interface modules 25 are provided.

Further, like in FIG. 2, the network interface module 25 and the mobility binding engine 26 can mutually transmit trigger signals and packets through a signal/data path S25. The network interface module 25 forwards, to the mobility binding engine 26, a BU message (individual registration BU message or bulk registration BU message) received, for example, from the MN 100 as a mobility signaling message received from another node to cause the mobility binding engine 26 process it. Similarly, the mobility binding engine 26 forwards a mobility signaling message to the network interface module 21 to cause the network interface module 21 send it to another node, e.g., a BA message (individual registration BA message or bulk registration BA message) to the MN 100.

The mobility binding engine 26 manages the mobility of the HA 101. Like in FIG. 2, if a term in the related technical field is used, the mobility binding engine 26 represents the function of a layer 3 (network layer) protocol such as MIPv4 or MIPv6 (Mobile Internet Protocol version 4 or 6). The mobility binding engine 26 and the database module 27 can mutually transmit trigger signals and packets through a signal/data path S26. For example, the mobility binding engine 26 updates information (e.g., care-of address) in the database module 27 or retrieves information from the database module 27 to execute the function of mobility management.

Similarly, the mobility binding engine 26 and the bulk registration verifying engine 28 can mutually transmit trigger signals and packets through a signal/data path S27. For example, the mobility binding engine 27 can trigger the bulk registration verifying engine 28 before refreshing the binding of an address of the MN 100 registered with the HA 101 to identify which address can be used for bulk registration (i.e., whether to authorize bulk registration therefor).

The database module 27 accumulates information necessary for the HA 101. In this preferred embodiment, the database module 27 accumulates a binding cache 270, a bulk registration valid period 271 and address verification information 272. The binding cache 270 includes one or more entries for the current care-of addresses of a destination node (e.g., the MN 100). In addition, in the first embodiment, the bulk registration valid period 271 is introduced into one or plural care-of addresses used by the MN 100 for bulk registration. The address verification information 272 includes data related to execution by the bulk registration verifying engine 28 (e.g., one or plural care-of addresses used for bulk registration, public key and private key). In the present invention, the bulk registration verifying engine 28 is introduced. The bulk registration verifying engine 28 aims to verify whether a care-of address in the bulk registration BU message is available for bulk registration. In another embodiment to be described later, a proxy helps the HA 101 make this verification.

### First Embodiment: HA Notifies MN of Advisability of Bulk Registration

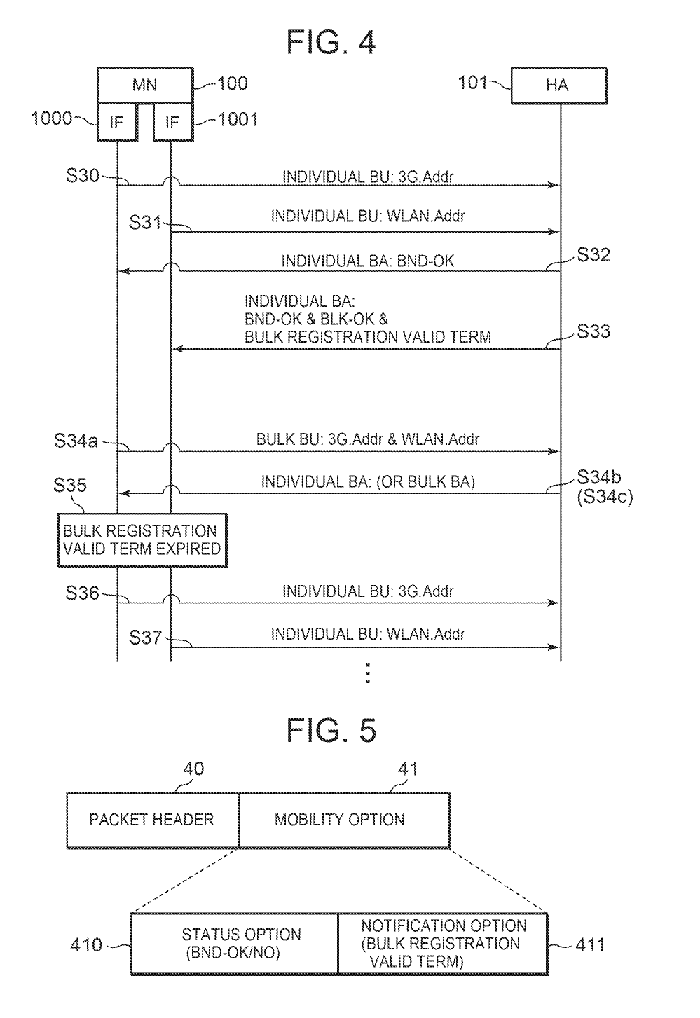

FIG. 4 shows a communication sequence of the first embodiment. Here, the MN 100 has the 3G cellular interface 1000 and the WLAN interface 1001, and the 3G cellular interface 1000 and the WLAN interface 1001 are using address 3G.Addr and WLAN.Addr, respectively. Further, it is assumed that the MN 100 is roaming around the foreign network domain 11 outside the home network domain 10 as shown in FIG. 1 and the HA 101 updates the care-of addresses currently used by the MN 100.

Therefore, the MN 100 sends the HA 101 an individual registration BU message S30 from the 3G cellular interface 1000 to register address 3G.Addr individually with the HA 101. Similarly, the MN 100 sends the HA 101 an individual registration BU message S31 (simply referred to as individual BU in the figure) from the WLAN interface 1001 to register address WLAN.Addr individually with the HA 101. Through the ingress filtering of the foreign network domain 11, the HA 101 is assured that the address 3G.Addr has come from a source to which the address is allocated. The HA 101 accepts the individual registration BU message S30 and returns, to the MN 100, a binding acknowledgment (individual registration BA) message S32 (simply referred to as individual BA in the figure) to individually give notice that the address 3G.Addr has been registered.

Likewise, processing for the address WLAN.Addr is also performed in a similar procedure based on the ingress filtering by the foreign network domain 11.

Here, the HA 101 detects that the MN 100 registers multiple care-of addresses and returns, to the MN 100, an individual registration BA message S33 describing that the address WLAN.Addr is available for bulk registration together with the notice of binding acknowledgment (BND-OK). In the individual registration BA message S33, the HA 101 also notifies the MN 100 of the bulk registration valid period of the address WLAN.Addr.

When trying to send the HA 101 the next BU message, the MN 100 checks whether the bulk registration valid period of the address WLAN.Addr has not expired yet. If the bulk registration valid period has not expired yet, the MN 100 continuously sends a bulk registration BU message S34a (simply referred to as bulk BU in the figure) to register the addresses 3G.Addr and WLAN.Addr with HA 101 as bulk registration. As a response to the bulk registration BU message S34, the HA 101 returns two individual registration BA messages S34b (individual registration BA message to 3G.Addr and individual registration BA message to WLAN.Addr) or one bulk registration BA message S34c.

If the bulk registration valid period has expired (S35 in the figure), the MN 100 sends the HA 101 individual registration BU messages S36 and S37 to register the addresses 3G.Addr and WLAN.Addr with the HA 101, respectively. The individual registration BU messages S36 and S37 allow the HA 101 to verify that the care-of addresses 3G.Addr and WLAN.Addr the MN 100 is trying to register are true on the assumption that the source address has been verified through the ingress filtering again.

When changing the address 3G.Addr or WLAN.Addr, the MN 100 does not include the address in the bulk registration BU message. The reason therefor is that a new IP address is not verified by the HA 101 using the ingress filtering. If the MN 100 uses bulk registration to register the new IP address, the HA 101 will trigger some sort of address verification mechanism to verify the new IP address before using the new IP address. Note that, after the verification of an address, the individual registration BA message S33 describing that the address is available for bulk registration (BLK-OK) may be returned to the MN 100. For example, when the MN 100 configures address WLAN.Addr2 as the new IP address of the WLAN interface 1001, since the address WLAN.Addr2 has not been verified by the HA 101 yet, the MN 100 registers the address WLAN.Addr2 with the HA 101 using an individual registration BU message. This technique enables the HA 101 to use ingress filtering to verify that the MN 100 is really using the address WLAN.Addr2. On the other hand, when the MN 100 tries to register the address WLAN.Addr2 with the HA 101 using bulk registration before sending the individual registration BU message to the HA 101, the HA 101 detects that the address WLAN.Addr2 does not exit in the binding cache 270. The HA 101 knows that the address WLAN.Addr2 is unavailable for bulk registration and makes an address verification.

Note that the HA 101 may send the MN 100 a message to give notice that only the bulk registration is rejected instead of making the address verification of the address unavailable for the bulk registration. This enables the MN 100 to make a decision whether to send an individual registration BU message again. Since the MN 100 itself can recognize that the individual registration BU message should be sent rather than bulk registration and start retransmission through the individual registration BU message, the load accompanied with the verification processing can be removed from the HA 101.

Further, when the address included in the bulk registration BU message does not exist in the binding cache 270 at all, the HA 101 may send a BA message to give notice that the above-mentioned bulk registration is rejected, while when it exists in the binding cache 270 but the bulk registration valid period has expired, address verification processing may be performed. This can limit the address verification by the HA 101 to specific cases, and hence reduce the load associated with the address verification. For example, when the load on the MN 100 associated with retransmission of individual BU messages is heavier than the load on the HA 101 associated with the address verification processing, the MN 100 may select transmission of a bulk registration BU message from the beginning to reduce the load on itself. The increase in the load on the HA 101 associated therewith is not desirable for the network operator. Therefore, as mentioned above, the opportunities for the HA 101 to perform address verification are minimized so that such an action of the MN 100 can be prevented.

<Format of Notification Message>

FIG. 5 shows the format of a notification message of the preferred first embodiment. This notification message has a packet header 40 and a mobility option 41. The packet header 40 has fields of message source, message type and message length, respectively. The message source is, but not limited to, an IPv4 or IPv6 address. The mobility option 41 has a status option 410 and a notification option 411. When this message is the individual registration BA message S32 or S33, the status option 410 indicates whether the registration of the care-of address requested through the individual registration BU message S30 or S31 is completed (BND-OK/NO). Further, when this message is the individual registration BA message S33 with the address WLAN.Addr and the bulk registration is registerable (BLK-OK), the notification option 411 includes the bulk registration valid period.

The following will describe the status option 410 and the notification option 411 in detail with reference to the example shown in FIG. 4. When the MN 100 sends the HA 101 the individual registration BU message S30 from the 3G cellular interface 1000 to register the address 3G.Addr individually with the HA 101, the HA 101 returns, to the MN 100, the individual registration BA message S32 including the status option 410 indicating that the registration of the address 3G.Addr is completed (BND-OK). Further, when the MN 100 sends the HA 101 the individual registration BU message S31 from the WLAN interface 1001 to register the address WLAN.Addr individually with the HA 101, the HA 101 returns, to the MN 100, the individual registration BA message S33 including the status option 410 describing that the registration of the address WLAN.Addr is completed (BND-OK) and the notification option 411 describing the bulk registration valid period (e.g., seven minutes) of the address WLAN.Addr. Thus, the MN 100 can send the bulk registration BU message S34a from the 3G cellular interface 1000 for seven minutes to refresh the address WLAN.Addr.

<Bulk Registration Valid Period>

It is preferred that the “bulk registration valid period” described in the notification option 411 should correspond to the lifetime of an IP address allocated by the foreign network domain 11 to the MN 100 to perform communication (hereinafter “address lifetime”) and the bulk registration valid period be equal to or shorter than the address lifetime. The description will be made by taking a case as an example in which the address lifetime of the address WLAN.Addr is assigned by a DHCP (Dynamic Host Control Protocol) server, not shown, located in the foreign network domain 11. When allocating the address WLAN.Addr to the MN 100, the DHCP server gives the address lifetime (e.g., seven minutes) of the address WLAN.Addr. During this address lifetime, the DHCP server does not allocate the address WLAN.Addr to another mobile node even if the MN 100 does not use the address WLAN.Addr.

The reason why the DHCP server works this way is that the MN 100 may suffer unexpected connection loss. Upon reconnection after the connection loss of the address WLAN.Addr, the MN 100 requests the address WLAN.Addr because it does not change the continuing session with the CN 300.

In this case, if the DHCP server allocates the address WLAN.Addr to another mobile node during a period from when the MN 100 loses the connection using the address WLAN.Addr until its reconnection, the MN 100 will not be able to use the address WLAN.Addr again. The fact that the MN 100 cannot use the address WLAN.Addr again means that the MN 100 needs to notify the CN 300 of a new IP address, and this implies that the communication service for the session between the MN 100 and the CN 300 is disrupted. Further, since the CN 300 does not know that the address WLAN.Addr is allocated to another mobile node, if the other mobile node uses the address WLAN.Addr, it will receive unnecessary packets from the CN 300. When the MN 100 is a malicious node, this action is regarded as a redirection attack.

The following will describe how the malicious MN 100 conducts a redirection attack using the DHCP server when the bulk registration valid period is not associated with the address lifetime being assigned from the DHCP server.

When the MN 100 is allocated, from the DHCP server, the address WLAN.Addr to be used in the foreign network domain 11, the MN 100 starts a session with the CN 300 using the address WLAN.Addr and continues the session for one minute after the start of packet transmission to the address WLAN.Addr. Next, the MN 100 loses the connection using the address WLAN.Addr deliberately to mislead the DHCP server into allocating the address WLAN.Addr to another mobile node. Once the other mobile node (i.e., victim) acquires the address WLAN.Addr, since packets from the CN 300 start arriving at the mobile node that becomes the victim, the MN 100 can succeed in causing the mobile node to receive a huge number of unnecessary packets.

Therefore, in this preferred first embodiment, the bulk registration valid period of the IP address notified from the HA 101 to the MN 100 is set equal to or shorter than the address lifetime assigned from the DHCP server in the foreign network domain 11. It is also preferred that when the bulk registration valid period is shorter than the address lifetime, the timing of expiration of the address lifetime coincides with the timing of expiration of the bulk registration valid period.

This can prevent a period during which the bulk registration valid period is still valid at the time of expiration of the address lifetime. Since the bulk registration valid period is introduced in this way, the above-mentioned redirection attack can be prevented. As an alternative embodiment, the bulk registration valid period may be a period known to all entities. As still another alternative embodiment, the bulk registration valid period may be a period negotiated between the home network domain 10 and the foreign network domain 11.

In addition, the bulk registration valid period can reduce the possibility that the MN 100 claims use of this IP address by mistake when the MN 100 has no longer used this IP address. For example, when the MN 100 shuts down the WLAN interface 1001, the MN 100 can deliberately send a bulk registration BU message from the 3G cellular interface 1000 to refresh the address WLAN.Addr to claim the use of the address WLAN.Addr. However, since the DHCP server does not allocate the address WLAN.Addr until the expiration of the address lifetime, the MN 100 cannot conduct a redirection attack on the mobile node that becomes a victim. Further, upon the expiration of the bulk registration valid period, the HA 101 needs to verify through the ingress filtering that the MN 100 is still using the address WLAN.Addr after sending an individual registration BU message from the WLAN interface 1001. Thus, the introduction of the bulk registration valid period can reduce the possibility that the MN 100 acts maliciously.

<Processing by MN>

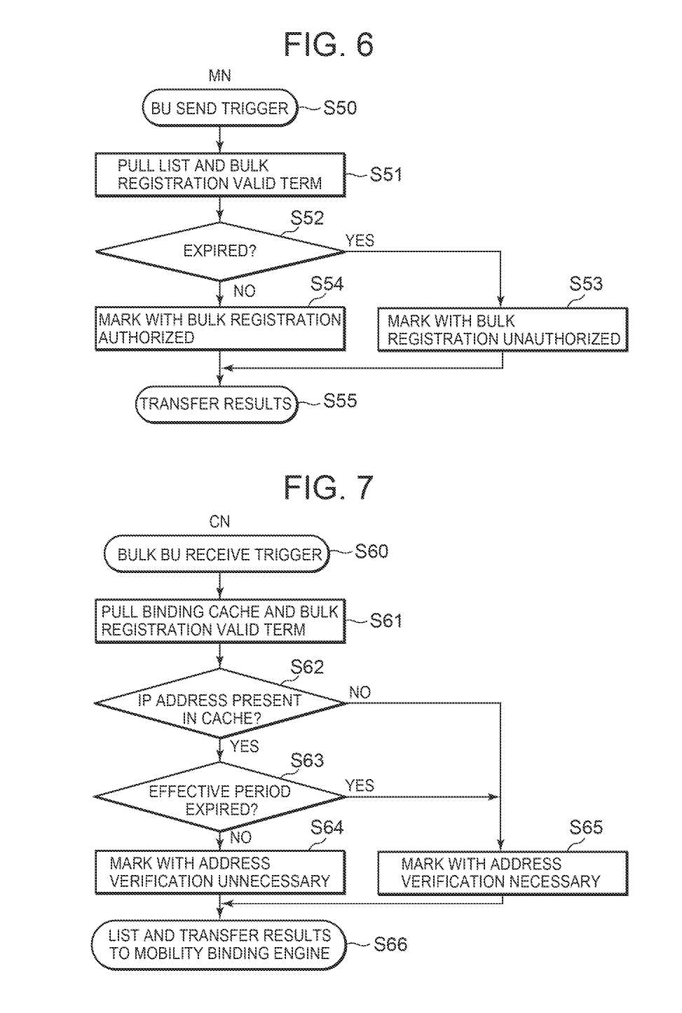

FIG. 6 is a flowchart for describing processing performed by the MN 100 to judge the advisability of bulk registration. If a BU message needs to be sent to the HA 101, this processing is started by the bulk registration advisability judging engine 24 when a trigger signal is received from the mobility binding engine 22 (BU receive trigger in step S50) to retrieve related information (e.g., the entries in the binding update list 230 and the bulk registration valid period 231) from the database module 23 (step S51). Then, based on the bulk registration valid period 231, it is checked whether the bulk registration valid period of the IP address has expired (step S52). If the bulk registration valid period has expired, the procedure proceeds to step S53 in which the IP address in the binding update list 230 is marked with “bulk registration unauthorized,” and then the procedure proceeds to step S55. On the other hand, if the bulk registration valid period has not expired, the procedure proceeds to step S54 in which the IP address in the binding update list 230 is marked with “bulk registration authorized,” and then the procedure proceeds to step S55. In step S55, when all the entries in the binding update list have been checked, the results (bulk registration unauthorized/bulk registration authorized) are listed and the list is transferred to the mobility binding engine 22. The mobility binding engine 22 selectively generates an individual registration BU message or a bulk registration BU message based on this list.

An example of the above processing will be described. Suppose that the MN 100 has already registered the addresses 3G.Addr and WLAN.Addr with the HA 101. Suppose also that the HA 101 notifies the MN 100 that the bulk registration of the address WLAN.Addr is available for seven minutes. Suppose further that the MN 100 needs to refresh the current binding at the HA 101 after four minutes. Further, suppose that the MN 100 sends the HA 101 a bulk registration BU message to refresh both the addresses 3G.Addr and WLAN.Addr because both of the addresses 3G.Addr and WLAN.Addr are still in use and the bulk registration valid period of the address WLAN.Addr has not expired yet. Further, suppose that the MN 100 needs to refresh the current binding at the HA 101 after additional four minutes. Although the MN 100 is still using both of the addresses 3G.Addr and WLAN.Addr, since the bulk registration valid period of the address WLAN.Addr has expired, the MN 100 sends the HA 101 individual registration BU messages to refresh the addresses 3G.Addr and WLAN.Addr individually.

<Processing by HA>

FIG. 7 is a flowchart for describing processing performed by the HA 101 to verify a bulk registration BU message from the MN 100. This processing is started when the mobility binding engine 26 receives the bulk registration BU message from the MN 100 and the bulk registration verifying engine 28 receives a trigger signal from the mobility binding engine 26 (bulk BU receive in step S60) to retrieve related information (i.e., the binding cache 270 and the bulk registration valid period 271) from the database module 27 (step S61). Next, it is checked whether an IP address described in the bulk registration BU message is present in the acquired binding cache 270 within the bulk registration valid period 271 (step S62), and if present, the procedure proceeds to step S63, while if not, the procedure proceeds to step S65.

In step S63, the bulk registration valid period 271 is referred to check whether the bulk registration valid period of the IP address has expired. If the bulk registration valid period of the IP address has not expired, the procedure proceeds to step S64, while if it has expired, the procedure proceeds to step S65.

In step S64, the IP address in the binding cache 270 is marked to indicate the verification of the address before packet forwarding is unnecessary (address verification unnecessary), and then the procedure proceeds to step S66. In step S65, the IP address in the binding cache 270 is marked to indicate that the verification of the address before packet forwarding is necessary (address verification necessary), and then the procedure proceeds to step S66. In step S66, the results are listed and the list is transferred to the mobility binding engine 26. The mobility binding engine 26 processes the bulk registration BU message based on this list (accept or reject, or the like).

An example of the above processing will be described. Suppose that the HA 101 currently has the active bindings to the addresses 3G.Addr and WLAN.Addr of the MN 100. Suppose also that the HA 101 has acknowledged that the bulk registration of the address WLAN.Addr is authorized for seven minutes. Suppose further that the HA 101 receives a bulk registration BU message from the MN 100 after four minutes to refresh the address WLAN.Addr.

Further, suppose that the HA 101 accepts the binding refresh request because the bulk registration valid period of the address WLAN.Addr has not expired. Further, suppose that the HA 101 receives a bulk registration BU message from the MN 100 after additional four minutes to refresh the address WLAN.Addr. Since the bulk registration valid period of the address WLAN.Addr has expired, the HA 101 moves to the procedure for verifying the address WLAN.Addr before sending packets to the address WLAN.Addr.

Further, when the MN 100 sends a bulk registration BU message to register new address WLAN.Addr2, since the address WLAN.Addr2 does not exist in the binding cache 270, the HA 101 triggers an address verification process. When the address verification of the address WLAN.Addr2 is successful, the HA 101 updates a binding entry associated with the address WLAN.Addr2. Thus, since the HA 101 notifies the MN 100 of the bulk registration valid period of the address WLAN.Addr, the MN 100 can know which type of BU message should be sent to the address WLAN.Addr. For the MN 100, this means no delay in packet forwarding using the address WLAN.Addr.

### Second Embodiment: MN Inquires of HA for Advisability of Bulk Registration

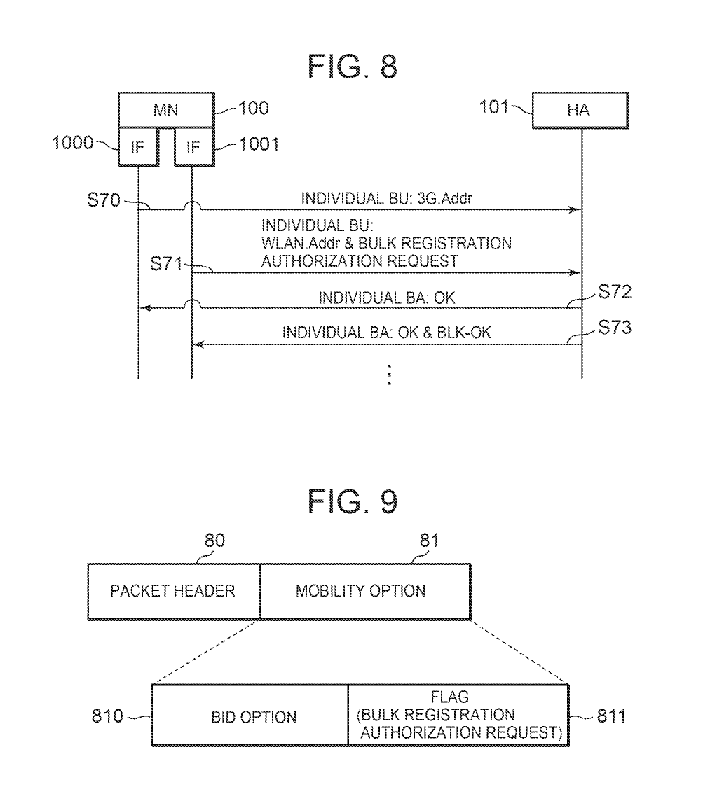

In a second embodiment, the MN 100 makes an inquiry to the HA 101 about whether bulk registration of a specific IP address desired for the bulk registration is possible. FIG. 8 shows a communication sequence of the second embodiment. First, like in the first embodiment, it is assumed that the MN 100 has the 3G cellular interface 1000 and the WLAN interface 1001, and the 3G cellular interface 1000 and the WLAN interface 1001 are using address 3G.Addr and WLAN.Addr, respectively. Further, it is assumed that the MN 100 is roaming around outside the home network domain 10 as shown in FIG. 1 and the HA 101 updates the care-of addresses currently used by the MN 100.

Therefore, the MN 100 sends the HA 101 an individual registration BU message S70 from the 3G cellular interface 1000 to register address 3G.Addr individually with the HA 101. Similarly, the MN 100 sends the HA 101 an individual registration BU message S71 from the WLAN interface 1001 to register address WLAN.Addr individually with the HA 101. In the second embodiment, the individual registration BU message S71 also includes an authorization request for bulk registration to inquire about whether bulk registration of the address WLAN.Addr is possible.

Since it is ensured through the ingress filtering that the HA 101 verifies that the address 3G.Addr has come from a target source, the HA 101 accepts the individual registration BU message S30 and returns, to the MN 100, an individual registration BA message S32 to individually send the binding acknowledgment (OK) of the address 3G.Addr. Further, since the ingress filtering is performed on the address WLAN.Addr in the same manner, the HA 101 not only sends the binding acknowledgment (OK) of the address WLAN.Addr individually, but also detects that the MN 100 registers multiple care-of addresses, returning, to the MN 100, an individual registration BA message S33 describing a response (BLK-OK) to authorize the bulk registration of the address WLAN.Addr.

Here, unlike in the first embodiment, there is no need for the HA 101 to estimate whether the MN 100 tries to use the bulk registration of specific IP addresses as the advantage of making an authorization request for bulk registration. This means that when the HA 101 does not receive the authorization request for bulk registration from the MN 100, the HA 101 can estimate that the MN 100 does not need bulk registration.

<Bulk Registration Authorization Request Message>

FIG. 9 shows the format of the individual registration BU message S71 including a bulk registration authorization request in the second embodiment to inquire about whether the bulk registration of the address WLAN.Addr is possible.

The message S71 has a packet header 80 and a mobility option 81. The packet header 80 has fields of message source, message type and message length, respectively. The message source is, but not limited to, an IPv4 or IPv6 address. The mobility option 81 includes a binding identifier (BID) option 810 and a flag 811. The BID option 810 generally indicates an identifier used by the MN 100 and the HA 101 to look up its binding cache so as to find a related binding entry faster. The flag 811 in the second embodiment is provided with one bit in the mobility option 81. When the flag 811 is the default value (=0), it indicates that the authorization request for bulk registration of the source address in the packet header 80 is not made, while when the flag 811=1, it indicates that the authorization request for bulk registration of the source address in the packet header 80 is made.

It will be apparent to those skilled in the art that the flag 811 can be provided as an option type. However, the present invention is not limited thereto. When it is provided as the option type, if the MN 100 desires to optimize the packet overhead resulting from multiple individual registration BU messages, this option can be attached to one individual registration BU message alone. This option indicates that the authorization request for bulk registration of multiple IP addresses is made. As an alternative embodiment, the flag 811 may also be a flag provided in the BID option 810. Further, this option can be attached to another form of message sent from the MN 100 to the HA 101.

An example of how the flag 811 is used will be described. When sending the HA 101 the individual registration BU message S71 from the WLAN interface 1001 to register the address WLAN.Addr individually with the HA 101, the MN 100 sets the flag 811 to 1 to make an inquiry to the HA 101 about whether bulk registration of the address WLAN.Addr is possible. The HA 101 uses some sort of function to determine whether the bulk registration of the address WLAN.Addr is possible. As this check function, the HA 101 makes an inquiry to an HSS server or an AAA server to check if the MN 100 signs up for the bulk registration service or whether the address WLAN.Addr has come from a reliable foreign 3GPP operator, but the function is not limited thereto. When the check is successful, the HA 101 returns, to the MN 100, an individual registration BA message indicating that the bulk registration of the address WLAN.Addr is possible (BLK-OK). Further, as an alternative embodiment, the HA 101 also notifies the MN 100 of the bulk registration valid period (e.g., seven minutes) of the address WLAN.Addr.

<Operation of MN>

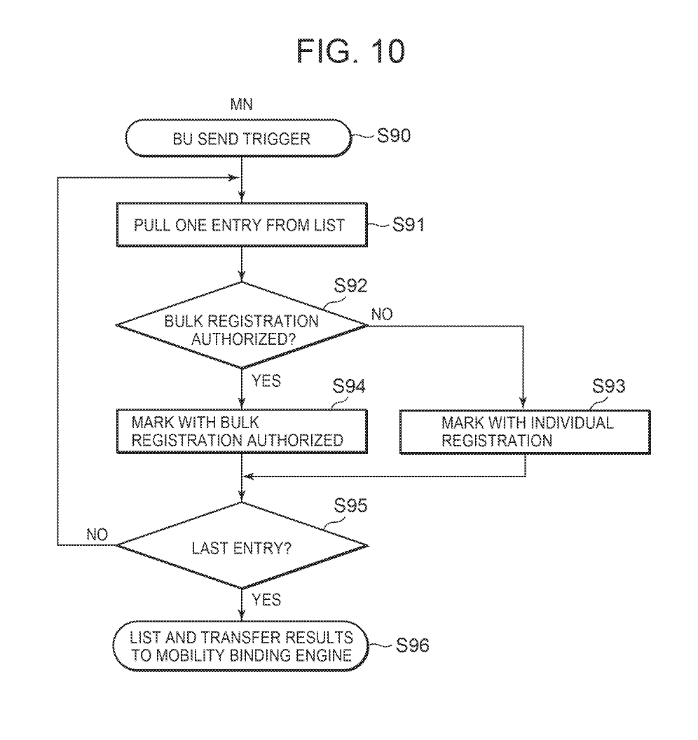

FIG. 10 shows processing performed by the MN 100 to judge the advisability of bulk registration. If a BU message needs to be sent to the HA 50, this processing is started when the bulk registration advisability judging engine 24 receives a trigger signal from the mobility binding engine 22 (BU send trigger in step S90) to pull one entry from the binding update list 230 in the database module 23 (step S91). Next, it is checked whether bulk registration of an IP address in the acquired entry is authorized (step S92). If not authorized, the procedure proceeds to step S93, while if authorized, the procedure proceeds to step S94. In step S93, the IP address in the entry is marked to indicate that individual registration must be made (individual registration=bulk registration unauthorized), and the procedure proceeds to step S95. In step S94, the IP address in the entry is marked to indicate that bulk registration is possible (bulk registration authorized), and the procedure proceeds to step S95. In step S95, it is judged whether all the entries in the binding update list 230 are checked. If not checked, the procedure returns to step S91, while if checked, the results are listed and the list is transferred to the mobility binding engine 22. The mobility binding engine 22 selectively generates an individual registration BU message or a bulk registration BU message based on this list.

An example of the above processing will be described. Suppose that the MN 100 has already registered the addresses 3G.Addr and WLAN.Addr with the HA 101. Suppose also that the HA 101 notifies the MN 100 that the bulk registration of the address WLAN.Addr is possible. In other words, the bulk registration of the address WLAN.Addr is authorized in the address verification information 232 at the MN 100. When there is the need to refresh the current binding at the HA 101, the MN 100 checks whether the bulk registration of the address WLAN.Addr is authorized. This check can be made by checking whether the address verification information 232 includes the address WLAN.Addr. Including the address WLAN.Addr means that the MN 100 can use the address WLAN.Addr for the bulk registration BU message.

Further, the HA 101 can update whether the MN 100 can use the IP address for bulk registration. As an alternative embodiment, the HA 101 can update the advisability status of the bulk registration of the MN 100 using the message shown in FIG. 9. For example, when determining that the address WLAN.Addr is no longer available, the HA 101 sends a BA message including the BID option 810 for the address WLAN.Addr and flag 811=0. Through this BA message, the HA 101 notifies the MN 100 that the WLAN.Addr is no longer available for bulk registration. Note that the type of message is not limited to the BA message, and a Binding Revocation message or a Binding Error message may be used.

<Processing by HA>

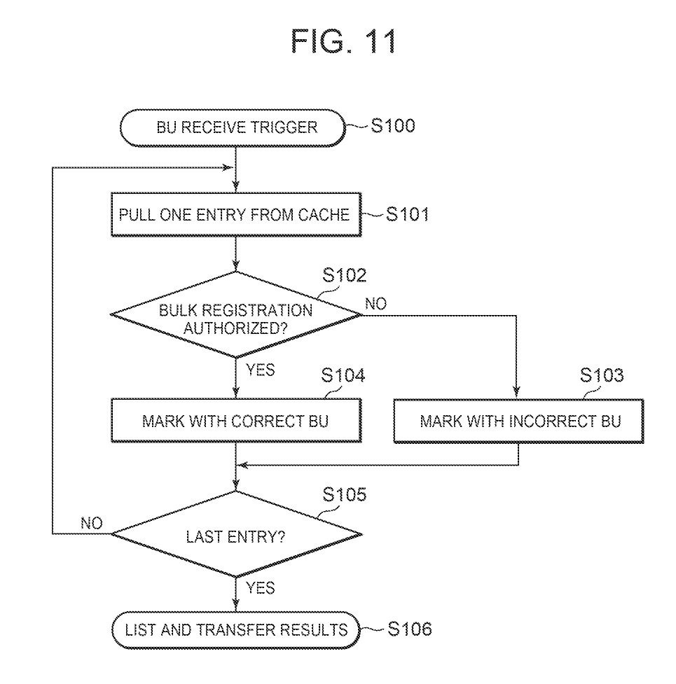

FIG. 11 shows processing performed by the HA 101 to verify a bulk registration BU message from the MN 100. This processing is started when the HA 101 receives the bulk registration BU message from the MN 100 and the bulk registration verifying engine 28 receives a trigger signal from the mobility binding engine 26 (bulk BU receive trigger in step S100) to first retrieve, from the binding cache 270, information (one entry) associated with the IP address in the received bulk registration BU message (step S101). Next, it is checked whether the bulk registration of the IP address in the acquired entry is authorized (step S102), and if not authorized, the procedure proceeds to step S103 to mark the IP address of the entry to indicate that the IP address in the received bulk registration BU message is “sent through an incorrectly formatted BU message.” On the other hand, if authorized, the procedure proceeds to step S104 to mark the IP address to indicate that the IP address in the received bulk registration BU message is “sent through a correctly formatted BU message.” Next, it is judged whether all the related entries in the cache 270 are checked. If not checked, the procedure returns to step S101, while if checked, the results are listed and the list is transferred to the mobility binding engine 26. The HA 101 conducts address verification on the “IP address sent through the incorrectly formatted BU message” or returns a response message to indicate that the bulk registration is not authorized.

An example of the above processing will be described. Suppose that the HA 101 currently has the active bindings to the addresses 3G.Addr and WLAN.Addr of the MN 100. Suppose also that the HA 101 has acknowledged that the bulk registration of the address WLAN.Addr is authorized. When the HA 101 receives a bulk registration BU message from the MN 100 to refresh the address WLAN.Addr, it is checked from the database module 27 whether the bulk registration of the address WLAN.Addr is authorized. This check can be made by determining whether the address WLAN.Addr exists in the address verification information 272. In other words, if the address WLAN.Addr exists, it is indicated that the bulk registration of the address WLAN.Addr is authorized, while if the address WLAN.Addr does not exist, it is indicated that the bulk registration of the address WLAN.Addr is not authorized. Depending on this status, the HA 101 accepts or rejects the refresh request for the address WLAN.Addr. As a result, when rejecting the refresh request, the HA 101 verifies the address WLAN.Addr before forwarding packets to the address WLAN.Addr.

Thus, since the MN 100 adds the bulk registration authorization request to the bulk registration BU message, the need for the HA 101 to estimate whether the MN 100 intends to make a bulk registration of a specific address can be eliminated. Further, the load on the HA 101 can be reduced, and hence a delay in packet forwarding to the specific address can be prevented.

### Third Embodiment: Proxy Assists in Address Verification

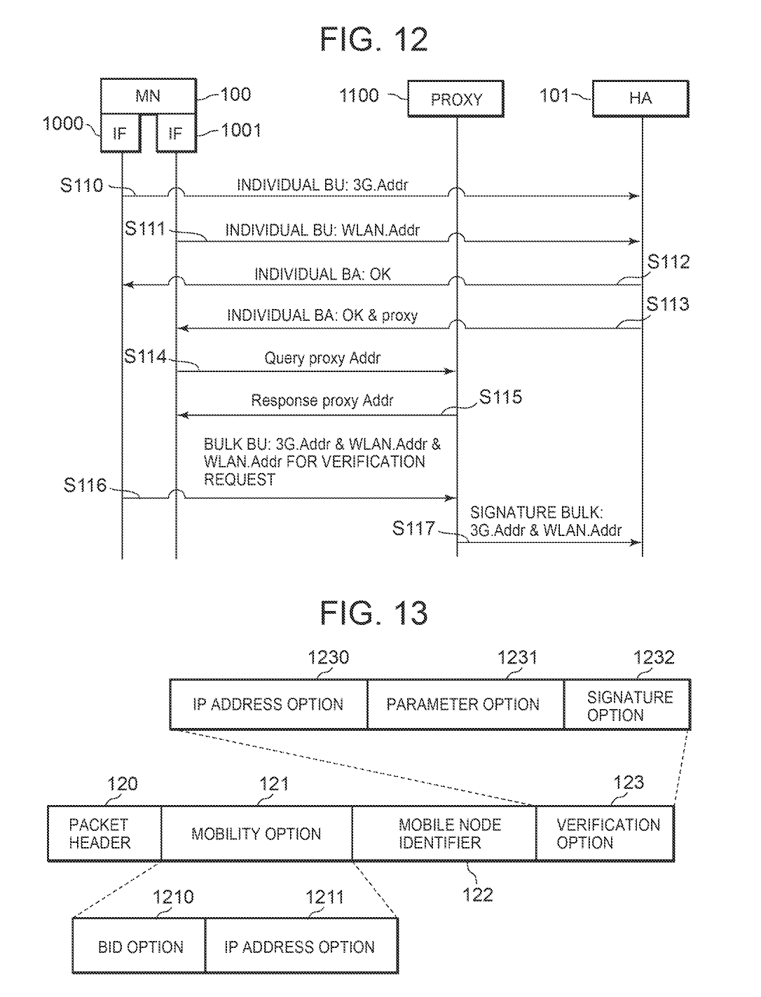

In a third embodiment, a proxy entity (proxy node) is used to assists in address verification of an IP address of the MN 100. It is preferred that the proxy entity be a local mobility anchor (LMA) employing a proxy mobile IP (PMIP) protocol. FIG. 12 shows a communication sequence of the third embodiment using a proxy 1100. First, like in the first and second embodiments, it is assumed that the MN 100 has the 3G cellular interface 1000 and the WLAN interface 1001, and the 3G cellular interface 1000 and the WLAN interface 1001 are using the addresses 3G.Addr and WLAN.Addr, respectively. It is also assumed that the MN 100 is roaming around outside the home network domain 10 as shown in FIG. 1 and the HA 101 is updated for the care-of addresses currently used by the MN 100. Therefore, the MN 100 sends the HA 101 an individual registration BU message S110 from the 3G cellular interface 1000 to register the address 3G.Addr individually with the HA 101. Similarly, the MN 100 sends the HA 101 an individual registration BU message S111 from the WLAN interface 1001 to register the address WLAN.Addr individually with the HA 101.

Since it is ensured through the ingress filtering that the HA 101 verifies that address 3G.Addr has come from a target source, the HA 101 accepts the individual registration BU message S30 and returns, to the MN 100, an individual registration BA message S112 to individually send the binding acknowledgment (OK) of the address 3G.Addr. Further, since the ingress filtering is performed on the address WLAN.Addr in the same manner, an individual registration BA message S113 is returned to the MN 100. The HA 101 detects that the MN 100 registers multiple care-of addresses. However, in the third embodiment, the HA 101 not only sends the binding acknowledgment (OK) of the address WLAN.Addr individually, but also returns, to the MN 100, an individual registration BA message S113 describing that the proxy 1100 for verifying the bulk registration BU message exists in the foreign network domain 11 (Proxy in the figure). As the method in which the HA 101 knows that the MN 100 is placed under the control of the proxy 1100, there is a method of identifying, from the prefix of the address WLAN.Addr, that the MN 100 is attached to a reliable foreign 3GPP operator network, but it is not limited thereto.

When receiving the individual registration BA message S113, the MN 100 makes inquiry to the foreign network domain 11 through a query message S114 about the IP address of the proxy 1100 (Query proxy Addr in the figure). In response to the query message S114, the proxy 1100 returns, to the MN 100, its IP address through a response message S115 (Response proxy Addr in the figure). In the third embodiment, a DNS (domain name service) protocol can be used for the query message S114 and the response message S115, but the present invention is not limited thereto. When knowing the IP address of the proxy 1100, the MN 100 sends the proxy 1100 a bulk registration BU message S116 from the 3G cellular interface 1000 to request verification of the address WLAN.Addr.

The bulk registration BU message S116 instructs the proxy 1100 that an IP address (i.e., the address WLAN.Addr) for which verification is requested is described in the message S116. The reason for notifying the proxy 1100 of the address WLAN.Addr is that the message S116 is encrypted between the MN 100 and the HA 101. This means that the proxy 1100 cannot decrypt the message S116 to verify whether the address WLAN.Addr is true or not. Therefore, the proxy 1100 once regards the IP address, for which the verification is requested in the message S116, as belonging to the MN 100, and sends the HA 101 a bulk registration BU message S117 with a signature affixed to the message S116. A CGA (cryptographically generated addresses) protocol can be used for this signature, but the present invention is not limited thereto. In the case of the CGA protocol, the proxy 1100 affixes the signature to the bulk registration BU message S117 using a secret key of the proxy 1100, and the HA 101 verifies the received bulk registration BU message S117 using a public key of the proxy 1100.

The advantage of using the proxy 1100 to verify the bulk registration BU message of the MN 100 is that the need for the MN 100 to encrypt the IP address is eliminated. The need for the MN 100 to encrypt the IP address is shifted to the proxy 1100 (e.g., server) so that the processing load of the MN 100 can be reduced. The proxy 1100 as a server has higher computing power than the MN 100.

<Bulk Registration BU Message>

FIG. 13 shows the format of the bulk registration BU message S116, S117 in the third embodiment. The message S116, S117 includes a packet header 120, a mobility option 121, a mobile node identifier 122 and a verification option 123. The packet header 80 has fields of a message source, a message type and a message length, respectively, and the message source is, but not limited to, an IPv4 or IPv6 address. The mobility option 121 includes a binding identifier (BID) option 1210 and an IP address option 1211. The BID option 1210 generally indicates an identifier used by the MN 100 and the HA 101 to look up its binding update list 230 and binding cache 270 so as to find a related binding entry faster.

The IP address option 1211 includes one additional IP address desired by the MN 100 to be registered with the HA 101 in addition to the source address of packet header 120. This additional IP address is associated with the BID in the BID option 1210. The bulk registration BU message S116, S117 may include more than one IP address option 1211. This means that the bulk registration BU message S116, S117 includes multiple BID options 1210 and multiple IP address options 1211. In the mobile node identifier 122, an identifier of the MN 100 that has sent this bulk registration BU message S116, S117 is described. The mobile node identifier 122 allows the proxy 1100 to know whether the additional IP address belongs to the MN 100 when verifying the bulk registration BU message S116.

The verification option 123 includes an IP address option 1230, a parameter option 1231 and a signature option 1232. In the IP address option 1230, an additional IP address on which the MN 100 has the proxy 1100 make a verification. It is preferred that the IP address in the IP address option 1230 should coincide with the IP address in the IP address option 1211. The parameter option 1231 instructs the HA 101 on a security parameter used by the proxy 1100 to verify the bulk registration BU message S116. It is preferred that information in the parameter option 1231 is an even-numbered parameter used for the public key of the proxy 1100 or used by the proxy 1100 for the CGA, but the present invention is not limited thereto.

At the end, the signature option 1232 generally includes the signature of the proxy 1100. This signature shows the HA 101 that the proxy 1100 verifies that the IP address in the bulk registration BU message S117 is true. It is preferred that this signature be the concatenation between the entire bulk registration BU message S117 and the private key of the proxy 1100. As an option, this signature may be part of the concatenation between the entire bulk registration BU message S117 and the private key of the proxy 1100 to reduce the packet size.

The reason why the proxy 1100 affixes the signature to the bulk registration BU message S116 is to prevent a malicious node from making a replay attack. The replay attack means that the malicious node steals and alters the bulk registration BU message S116, S117, and sends it to the HA 101 later. For example, when the proxy 1100 verifies the bulk registration BU message S116 for the address WLAN.Addr, the proxy 1100 describes the address WLAN.Addr in the verification option 123 alone and affixes the signature.

The HA 101 verifies that this signature is correct, accepts the address WLAN.Addr and registers it in the binding cache 230.

Suppose that the malicious node steals the bulk registration BU message S117, changes the IP address in the IP address option 1211 to another IP address, and sends the changed bulk registration BU message S117 to the HA 101. The HA 101 that has confirmed that the signature is correct as mentioned above notices that the address WLAN.Addr in the verification option 123 is different from the IP address in the IP address option 1211. Thus, the HA 101 deletes the address WLAN.Addr from the binding cache 230 as being the source as a malicious node. Such an operation can prevent the malicious node from abusing the address WLAN.Addr to disrupt the communication service. In order to prevent malicious activities, the proxy 1100 should affix the signature to the entire bulk registration BU message S117. This method can make it difficult for the malicious node to alter the bulk registration BU message S117.

<Processing by Proxy>

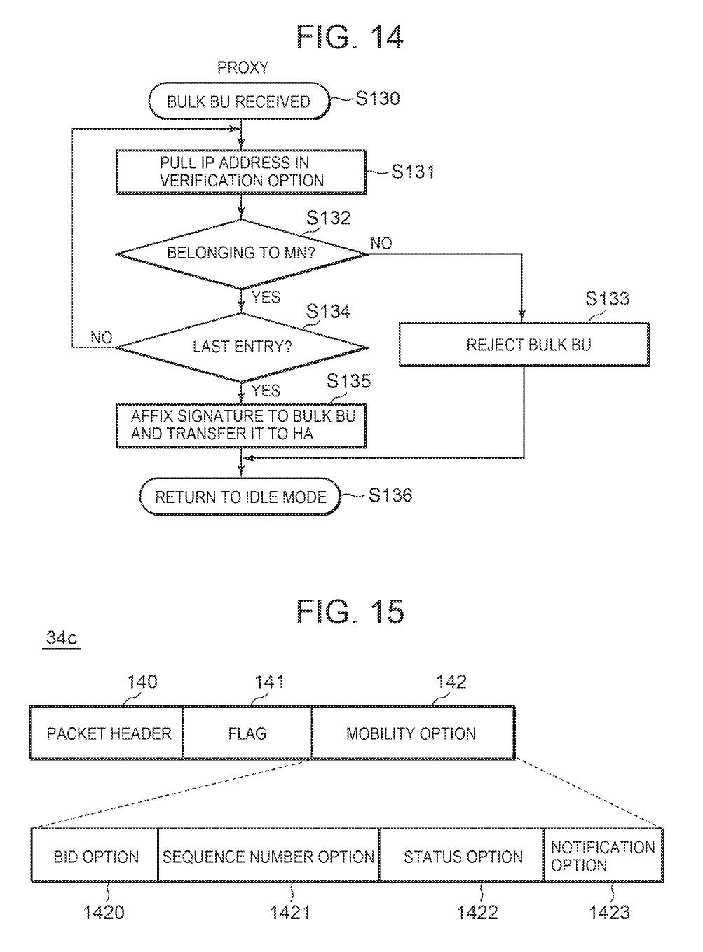

FIG. 14 shows processing performed by the proxy 1100 to assist in verification of the IP address in the bulk registration BU message S116. This processing is started when the bulk registration BU message S116 is received (step S130) to pull one IP address from the verification option 123 in the message S116 (step S131) and check whether the IP address is actually used by the MN 100, i.e., whether the IP address belongs to the MN 100 (step S132). As one check method, it id judged whether, in the database of the proxy 1100, the IP address corresponds to the mobile node identifier in the bulk registration BU message S116. If it is judged that the IP address does not belong to the MN 100, the bulk registration BU message S116 is rejected and the procedure returns to the idle mode (step S136) without checking any other IP address in the verification option 123 (step S133).

On the other hand, if it is judged in step S132 that the IP address belongs to the MN 100, it is then checked whether any remaining IP address exists in the verification option 123 (step S134). If exists, the procedure returns to step S131. If there exists no remaining IP address in the verification option 123 in step S134, the signature is affixed to the entire bulk registration BU message S116, the message is forwarded to the HA 101 (step S135), and the procedure returns to the idle mode (step S136).

The processing performed by the proxy 1100 will be described in more detail. When receiving the bulk registration BU message S116, the proxy 1100 confirms, based on the mobile node identifier 122, that the bulk registration BU message S116 has come from the MN 100. Further, from the IP address option 1230 in the verification option 123, the proxy 1100 knows that the MN 100 wants to register the address WLAN.Addr with the HA 101. The proxy 1100 checks its database to determine whether the address WLAN.Addr has been allocated to the MN 100 in the foreign network domain 11. It is preferred that the proxy 1100 should make an inquiry to a DCHP server about whether the address WLAN.Addr has been allocated to the MN 100. If the response from the DCHP server is affirmative, the proxy 1100 attaches the signature to the signature option 1232 and forwards the bulk registration BU message S117 to the HA 101 for the MN 100. On the other hand, if the response from the DCHP server is negative, the proxy 1100 rejects the bulk registration BU message S116. As a result, the proxy 1100 can mark it for future check to indicate that the source of the bulk registration BU message S116 is suspected of being a malicious node.

Use of the proxy 1100 enables reduction in the number of entities with which the HA 101 will communicates to verify the IP address of the MN 100. For example, the HA 101 has only to communicate with a selected anchor point selected in the global communication domain 12 rather than with thousands of mobile nodes under the domination of the global communication domain 12. Further, the reduction in communication channels can prevent a delay in use of the care-of addresses by the MN 100 for packet forwarding.

### Fourth Embodiment: MN/HA Determine the Advisability of Bulk Registration Depending on Foreign Network

In a fourth embodiment, for example, the MN 100 makes a judgment as to whether to make a bulk registration upon initial boot-up in the foreign network domain 11 based on information previously notified from the HA 101. It is preferred that the information be information indicating that in which of access networks the bulk registration of an IP address is possible (whether it is available for bulk registration). However, the present invention is not limited thereto. For example, based on an access network to which the MN 100 is connected, the HA 101 updates the bulk registration operation of the MN 100. When acknowledging that the MN 100 is connected to a globally interoperable microwave access network (WiMAX network), the HA 101 notifies the MN 100 that any WiMAX address of the MN 100 can be used for bulk registration (BLK-OK). It is preferred that the way in which HA 101 knows in which of access networks connected to the MN 100 the bulk registration is possible depends on the negotiation between the home network domain 10 and the foreign network domain 11. The MN 100 sends the HA 101 a bulk registration BU message to make a bulk registration of a WiMAX address whenever the MN 100 wants to have the HA 101 update the WiMAX address.

As an alternative embodiment, information indicating what type of IP address is used for bulk registration is preset at the MN 100. According to his technique, the need to communicate this information between the MN 100 and the HA 101 can be eliminated. When knowing what type of access network is reliable for the HA 101, the MN 100 knows the type of BU message to be sent to the HA 101, and this can prevent a delay in use of the care-of addresses by the MN 100 for packet forwarding.

### Fifth Embodiment: MN Switches Between Source Addresses to Extend the Length of Bulk Registration Valid Period

In a fifth embodiment, the MN 100 uses a bulk registration BU message to extend the length of the bulk registration valid period for each individual address. To realize this technique, the MN 100 alternately uses the interfaces 1000 and 1001 when updating IP addresses at the HA 101. According to this technique, IP addresses sent using the source address of a bulk registration BU message are alternately verified through the ingress filtering.

A specific example will be described below. When the MN 100 registers both of the addresses 3G.Addr and WLAN.Addr with the HA 101, since the WLAN access network 111 is unstable, the HA 101 assigns five minutes to the bulk registration valid period for the address WLAN.Addr. On the other hand, since the 3G cellular network 11 is stable, the HA 101 assigns seven minutes to the bulk registration valid period for the address 3G.Addr. After five minutes, when the MN 100 needs to refresh the registration of the addresses 3G.Addr and WLAN.Addr with the HA 101, since the bulk registration valid period for the address 3G.Addr is still active, the MN 100 sends a bulk registration BU message with the source address set as the address WLAN.Addr and an additional IP address set as the address 3G.Addr. According to this technique, not only is the address WLAN.Addr verified through the ingress filtering, but also the need to send an individual registration BU message for the address 3G.Addr can be eliminated. When the address WLAN.Addr is verified through the ingress filtering, the HA 101 extends the length of the bulk registration valid period for the address WLAN.Addr.

As an alternative embodiment, the bulk registration valid period for all IP addresses of the MN 100 are made the same. Therefore, the length of the bulk registration valid period for each IP address can be extended by changing the source address by rotation or pairing two IP addresses (where either of them is set to the source address).

The fact that the interfaces 1000 and 1001 can be alternately used when the MN 100 updates the registration of IP addresses with the HA 101 means that the MN 100 quickly negotiates with the HA 101 to enable the extension of the length of the bulk registration valid period for a specific IP address. Because of this efficient negotiation with the HA 101, a delay in use of care-of addresses by the MN 100 for packet forwarding can be prevented.

### Sixth Embodiment: Bulk BA

In a sixth embodiment, one BA message (hereinafter, bulk registration BA message 34c) is returned instead of returning the multiple individual registration BA messages S32, S33 and S34b in FIG. 4 from the HA 101 to the MN 100 as a response to the individual registration BU messages S30, S31 and the bulk registration BU message 34a. FIG. 15 shows the format of the bulk registration BA message 34c. The bulk registration BA message 34c includes a packet header 140, a flag 141 and a mobility option 142. The packet header 140 has fields of message source, message type and message length, respectively. The message source is, but not limited to, an IPv4 or IPv6 address. The flag 141 is used by the HA 101 to notify the MN 100 whether this bulk registration BA message 34c includes different notifications on bulk registration for respective IP addresses. The flag 141 may be one bit. The default value(=0) indicates that all notifications in this bulk registration BA message 34c are the same. On the other hand, when flag 141=1, it indicates that notifications in this bulk registration BA message 34c are different. In this case, the MN 100 needs to check for each individual notification in the mobility option 142.

The mobility option 142 includes a BID option 1420, a sequence number option 1421, a status option 1422 and a notification option 1423. The BID option 1420 indicates BID allocated to an IP address the MN 100 registers with the HA 101. It is preferred that the BID described in the BID option 1420 be the BID described in the bulk registration BU message 34a sent from the MN 100 to the HA 101. The sequence number option 1421 typically indicates a sequence number transmitted through the bulk registration BU message 34a received by the HA 101. The sequence number enables the MN 100 to determine whether the bulk registration BU message 34a sent by the MN 100 corresponds to this bulk registration BA message 34c.

The status option 1422 notifies the MN 100 whether the registration of a specific IP address with the HA 101 is successful. Further, the status option 1422 typically notifies the MN 100 of the reason why the HA 101 rejects the registration. The last notification option 1423 indicates the intention of the HA 101 as to whether the bulk registration of the specific IP address is possible. It is preferred that the notification option 1423 further indicate the bulk registration valid period. This bulk registration BA message can include more than one mobility option 142. In other words, the bulk registration BA message 34c can include multiple BID options 1420, multiple sequence number options 1421, multiple status options 1422 and multiple notification options 1423, respectively corresponding to individual addresses for which the registration is requested through the individual registration BU messages S30, S31 and the bulk registration BU message 34a.

As an alternative embodiment, this bulk registration BA message 34c may include the same sequence number. For example, when the MN 100 sends one bulk registration BU message 34a to the HA 101, this bulk registration BU message 34a is identified by one sequence number. In this case, the HA 101 can use one sequence number option 1421 for all registered IP addresses to optimize the packet size of the bulk registration BA message 34c.

As another alternative embodiment, the bulk registration BA message 34c may include the same status. For example, if the HA 101 accepts the registration of all IP addresses in the bulk registration BU message 34a, one status option 1422 can be used to indicate the status of all the IP addresses. As still another alternative embodiment, this bulk BA message may include the same notification. For example, if the HA 101 assigns the same bulk registration valid period to all registered IP addresses, one notification option 1423 can be used to indicate a common bulk registration valid period in order to optimize the packet size of the bulk registration BA message 34c.

Further, one mobility option 142 may be included to indicate that all the IP addresses are registered, instead of including mobility options 142 for all the registered IP addresses, respectively. In this case, it is preferred that special values be specified as the value of the BID option 1420 and the value of the status option 1422 in one mobility option 142 included in the bulk registration BA message 34c to indicate that all the IP addresses are registered.

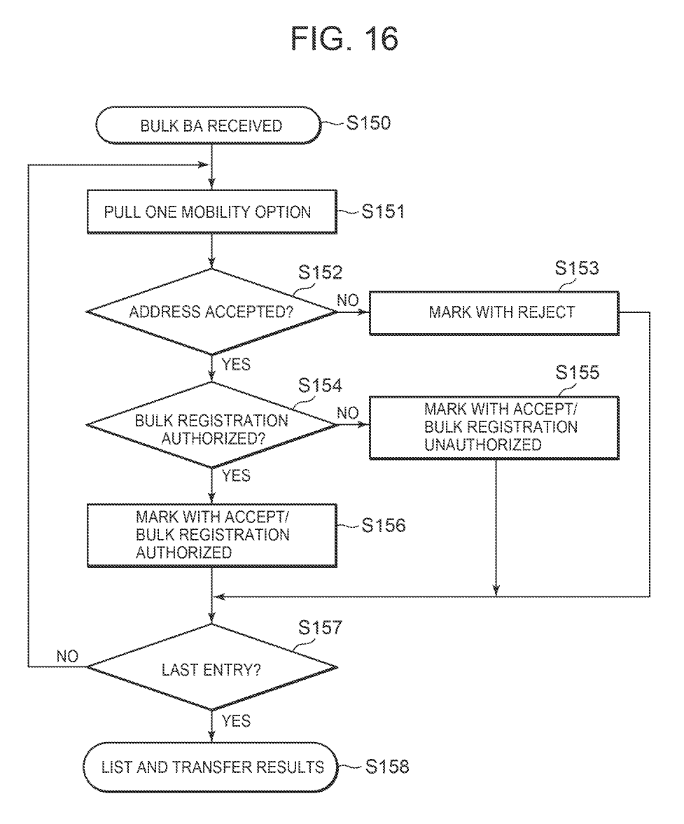

FIG. 16 shows processing when the MN 100 receives the bulk registration BA message 34c. This processing is started when the bulk registration BA message 34c is received from the HA 101 (step S150) to pull one mobility option 142 from the received message 34c (step S151). After the one mobility option 142 is pulled, it is checked, based on the status option 1422 in the mobility option 142, whether one IP address registration request is accepted (step S152). If not accepted, the IP address is marked with “reject” (step S153), and the procedure proceeds to step S157.

If the one IP address registration request is not accepted in step S152, it is checked whether the bulk registration of the IP address is made (step S154). If the bulk registration is not made, the IP address is marked with “accept” and “bulk registration unauthorized” (step S155), and the procedure proceeds to step S157. If the bulk registration is made in step S154, the IP address is marked with “accept” and “bulk registration authorized” (step S156), and the procedure proceeds to step S157. In step S157, it is checked whether there is the next mobility option 142 in the received message 34c. If there is the next mobility option 142, the procedure returns to step S151, while if it is the last mobility option 142, the processing results are listed and the list is transferred to the mobility binding engine 22 to update the binding update list 230 (step S158).

A specific example will be described. Suppose that the MN 100 is currently using the bulk registration to refresh the addresses 3G.Addr and WLAN.Addr at the HA 101. Based on the bulk registration valid periods for the authorized addresses 3G.Addr and WLAN.Addr, the MN 100 knows that the bulk registration valid periods for the addresses 3G.Addr and WLAN.Addr will expire soon. This implies that the MN 100 needs to send individual registration BU messages to individually refresh the addresses 3G.Addr and WLAN.Addr. When receiving these individual registration BU messages, the HA 101 needs to notify the MN 100 of new bulk registration valid periods respectively for the addresses 3G.Addr and WLAN.Addr. Therefore, instead of sending individual registration BA messages 34b, the HA 101 uses the bulk registration BA message 34c to notify the MN 100 the respective bulk registration valid periods for the addresses 3G.Addr and WLAN.Addr. According to this technique, the number of messages to be sent from the HA 101 to the MN 100 can be optimized.

The use of the bulk registration BA message 34c can streamline the method by which the HA 101 notifies the MN 100 of the status of support for the bulk registration of the IP addresses of the MN 100. Thus, a delay in use of care-of addresses by the MN 100 for packet forwarding can be prevented.

### Seventh Embodiment: HA Gives Instruction on Bulk BU Sending IF

In a seventh embodiment, the HA 101 instructs the MN 100 on which of the IFs 1000 and 1001 should send the bulk registration BU message 34a. Referring to FIG. 8, the seventh embodiment will be described. The individual registration BA message S73 for the address WLAN.Addr sent from the HA 101 to the MN 100 gives instruction on the IF from which the bulk registration BU message 34a should be sent. For example, the HA 101 assumes that the MN 100 hopes to send the bulk registration BU message 34a from the IF 1001 (address WLAN.Addr). In this case, when the MN 100 needs to send the bulk registration BU message 34a to update the registration of both of the addresses 3G.Addr and WLAN.Addr with the HA 101, the MN 100 sends the bulk registration BU message 34a from the IF 1001 (address WLAN.Addr) instructed by the HA 101. In other words, in this case, 3G.Addr becomes the address for which the bulk registration is made. Note that, instead of giving instruction on the IF from which the bulk registration BU message should be sent, the address for which the bulk registration is authorized may be instructed. For example, when the HA 101 judges that the address 3G.Addr of the MN 100 can be inserted into the registration BU message for the address WLAN.Addr and sent as a bulk registration message, information indicating bulk registration is included in the individual registration BA message S72. On the other hand, when the HA 101 judges that the address WLAN.Addr of the MN 100 can be inserted into the registration BU message for the address 3G.Addr and sent as a bulk registration message, information indicating bulk registration is included in the individual registration BA message S73.

### Eighth Embodiment: IF 1000 of UE is Directly Connected to Home Network Domain 10

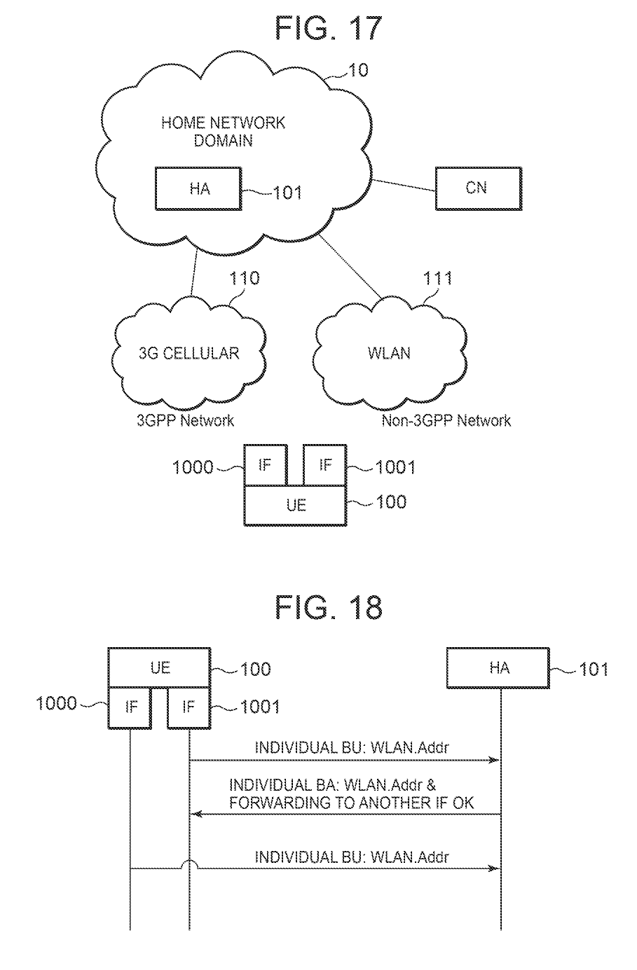

In an eighth embodiment, as shown FIG. 17, when the IF 1000 of a UE 100 is directly connected to a home network domain 10 of the UE 100 through a 3G cellular 110 and the IF 1001 is connected to the home network domain 10 through a non-3GPP network such as a WLAN 111 (or WiMAX, HRPD: High Rate Packet Data), the HA 101 gives instruction on the IF from which an individual registration BU message to give notice and register an IP address acquired from the WLAN 111 as a CoA should be sent. A point different from the seventh embodiment of the present invention is that, since the network connected to the IF 1000 (3G interface, 3G-IF) is the home network domain 10 rather than the foreign network domain, a message sent from the IF specified by the HA 101 is an individual registration BU message including the CoA related to the IF 1001 (WLAN interface, WLAN-IF) rather than the bulk registration BU message. In other words, the HA 101 specifies an IF from which a BU message is sent, but the BU message sent by the UE 100 that received the BU message is not limited to a bulk registration BU message. In the case of the connecting condition shown in FIG. 17, an individual registration BU message is sent from the specified IF.

As described in this embodiment, if the UE 100 can send an individual registration BU message as well as the bulk BU message from the IF 1000, both the UE 100 and the home network domain 10 can obtain the benefit of being able to send BU messages by taking advantage of various benefits (stable band frequency (QoS) and connecting condition, robust security and shortest path to the HA 101) provided by the 3G cellular 110.

Usually, since the connection to the 3G cellular 110 is managed by a network-based mobility control protocol such as PMIP or GTP (GPRS Tunneling Protocol), the UE 100 does not need to give notice of the address allocated to the IF 1000 through an individual registration BU message, enabling direct use of the allocated address as the home address (HoA). On the other hand, since the UE 100 uses MIPv6 (or MIPv4) for connection to a non-3GPP network, the UE 100 registers, from the WLAN 111, the allocated address with the HA 101 as a CoA for the HoA.

FIG. 18 represents a message sequence in this embodiment. The UE 100 sends the HA 101 an individual registration BU message to register the IP address of the IF 1001 connected to a non-3GPP network. The HA 101 that received the individual registration BU message from the UE 100 judges whether to permit the UE 100 to use the IF 1000 to send an individual registration BU message in order to update the registered binding cache. This judgment can be made, for example, by making sure whether the network (WLAN 111) to which the notified CoA is allocated is a network reliable for the home network domain 10, but the present invention is not limited thereto. Further, when the non-3GPP network is a network managed by the operator to which the HA 101 belongs, it may be judged that the use of the IF 1000 is permitted. Furthermore, when BU messages sent from the IF 1001 have been received a certain number of times, it may be instructed to send subsequent BU messages from the IF 1000. Furthermore, when the UE is connected to the same non-3GPP network for more than a fixed period of time, it may be instructed to send subsequent BU messages from the IF 1000.

When the HA 101 permits transmission of an individual registration BU message using the IF 1000, the HA 101 returns, to the UE 100, an individual registration BA message as a response including the status indicating that use of the IF 1001 is permitted (the IF 1000 is used). Note that the HA 101 may give notice of the 3G-IF valid period indicative of the period during which the use of the IF 1000 is permitted.

The UE 100 that received the individual registration BA message stores information indicating that the use of the IF 1000 is possible in a binding update list entry associated with the IP address of the IF 1001. Then, when an individual registration BU message is sent to update the binding cache, the binding update list entry is referred to check whether the use of the IF 1000 is possible. As s result of the check, if the use of the IF 1000 is possible, an individual registration BU message to register the IP address of the IF 1001 is sent using the IF 1000. Note that, if the 3G-IF valid period is notified, the information indicating that the use of the IF 1000 is possible in the binding update list entry is overridden at the time when the 3G-IF valid period has passed. When an individual registration BU message is sent after being overridden, the IF 1001 is used.

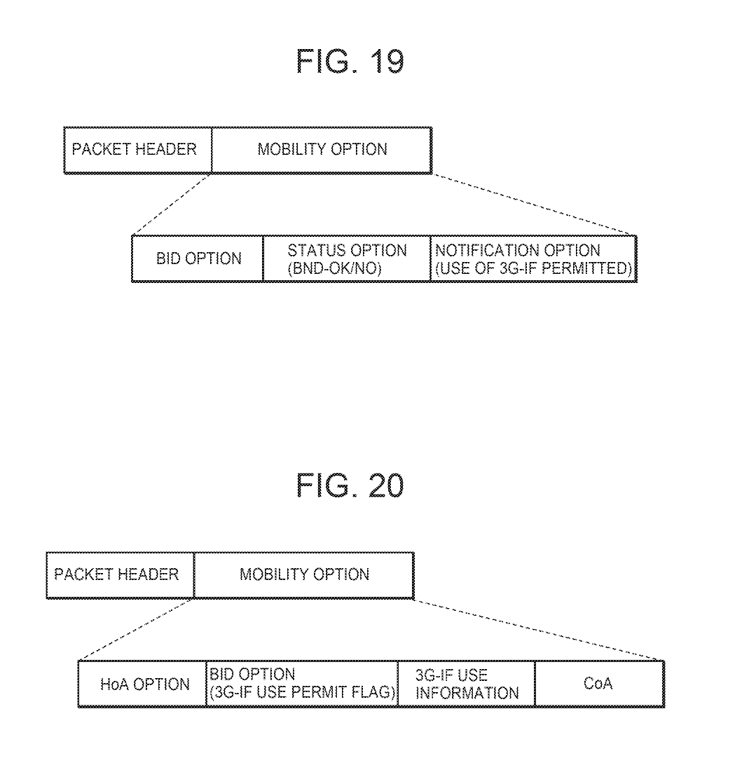

FIG. 19 shows an example of the format of the individual registration BA message. Included in the mobility option are a BID option including a BID corresponding to the CoA to be registered, a status indicative of the registration result of the CoA and a notification option indicating whether use of the IF 1000 for subsequent transmission is possible (3G-IF use permit information). When the status is OK, the 3G-IF use permit information indicates authorized or unauthorized. Note that the status and the 3G-IF use permit information may be included in the BID option or in a BA header (not shown).

FIG. 20 shows an example of the format of the individual registration BU message upon transmission using the IF 1000. In a source address of a packet header, the IP address (home address) allocated to the IF 1000 is set, and in a destination address, the address of the HA 101 is set. A BU header is also included in the packet header. Further, a HoA option including the home address, the CoA to be registered and a corresponding BID are included as the mobility option. Further, 3G-IF use information is included to distinguish the individual registration BU message as the message sent using the 3G-IF from normal individual registration BU messages. The 3G-IF use information may be included as a flag (3G-IF use permit flag) in the BID option. The CoA may also be included in the BID option. The individual registration BU message upon transmission from the IF 1000 may be sent using a method of encapsulating, with the address of the IF 1000, the individual registration BU message upon transmission from the IF 1001 may be employed. Further, it may be sent by adding a routing header including the CoA instead of the encapsulation.

Describing the structure of the UE 100 with reference to FIG. 2, the bulk registration advisability judging engine 24 functions as a 3G-IF use advisability judging engine in this embodiment. In other words, when the update of the binding cache is triggered by the mobility binding engine 22, the 3G-IF use advisability judging engine refers to the binding update list 230 in the database module 23 upon registration of the IP address of the IF 1001 to check whether use of the IF 1000 is permitted or whether use of the IF 1000 is specified. As a result of the check, if the use of the IF 1000 is permitted, the individual registration BU message shown in FIG. 20 is generated and sent using the IF 1001.

The structure of the HA 101 will be described with reference to FIG. 3. In the seventh embodiment, the bulk registration authorized by the bulk registration verifying engine 28 means that the UE 100 is allowed to include the CoA of the IF 1001 in a BU message to be sent from the IF 1000. Therefore, the HA 101 of the embodiment can be defined to make the same judgment as the advisability judgment on bulk registration in the seventh embodiment. On the other hand, the HA 101 of this embodiment can also be defined to make an advisability judgment on transmission of an individual registration BU message using the 3G-IF. In this case, the bulk registration verifying engine 28 functions as a 3G-IF use verifying engine. In other words, it is judged whether the UE 100 is permitted to use the IF 1000 to send the individual registration BU message received by the mobility binding engine 26. If it is judged to be permitted, information indicative of permission is stored in the binding cache 270 and an individual registration BA message including the status indicative of permission is returned.

According to the eighth embodiment of the present invention, the UE 100 can know that a BU message to register an IP address allocated to the IF connected to a non-3GPP network can be sent from the IP connected to a 3G network, enabling transmission of a BU message using the stable and reliable 3GPP network rather than the unstable non-3GPP network.

While the preferred embodiments of the present invention have been described, it will be apparent to those skilled in the art that various modifications may be made without departing from the scope of the present invention. For example, it will be apparent to those skilled in the art that the MN 100 can be applied to a mobile router employing a network mobility (NEMO) protocol. In this case, the mobile router uses the bulk registration BU message 34a to register a prefix with the HA 101. This implies that an IP address configured in the range of the prefix belongs to the mobile router.

The present invention can also be applied to a mobile access gateway (MAG) employing a proxy mobile IP (PMIP) protocol. Here, the MAG is the proxy 1100 in the aforementioned embodiment to help the local mobility anchor (LMA) verify an IP address. Therefore, the MAG registers, with the LMA, IP addresses of many mobile nodes (mobile nodes and mobile routers) using the bulk registration BU message 34a.

In addition, the present invention can be applied to a foreign agent employing MIPv4 (mobile IP version 4). In this case, the foreign agent helps the MN 100 register multiple IP addresses with the HA 101 using the bulk registration BU message 34a. Further, the foreign agent can be the proxy 1100 in the aforementioned embodiment so that it will help the HA 101 verify an IP address.

Finally, while the aforementioned embodiments have been described by taking the case as an example in which the HA 101 is the receiving side of the BU messages S30, S31, S34a and the like from the MN 100 and the sending side of the BA messages S32, S33, S34b, S34c and the like to the MN 100, those skilled in the art will appreciate that even if the HA 101 is replaced with another entity (e.g., node as a communication partner, router as a communication partner or LMA), it can receive the BU message S30, S31, S34a and the like from the MN 100 and send the BA messages S32, S33, S34b, S34c and the like to the MN 100.

Each functional block used in the explanations of each embodiment of the present embodiment, described above, can be realized as a large scale integration (LSI) that is typically an integrated circuit. Each functional block can be individually formed into a single chip. Alternatively, some or all of the functional blocks can be included and formed into a single chip. Although referred to here as the LSI, depending on differences in integration, the integrated circuit can be referred to as the integrated circuit (IC), a system LSI, a super LSI, or an ultra LSI. The method of forming the integrated circuit is not limited to LSI and can be actualized by a dedicated circuit or a general-purpose processor. A field programmable gate array (FPGA) that can be programmed after LSI manufacturing or a reconfigurable processor of which connections and settings of the circuit cells within the LSI can be reconfigured can be used. Furthermore, if a technology for forming the integrated circuit that can replace LSI is introduced as a result of the advancement of semiconductor technology or a different derivative technology, the integration of the functional blocks can naturally be performed using the technology. For example, the application of biotechnology is a possibility.

According to the present invention, the following inventions are provided in addition to the inventions as set forth in the appended claims:

(1) The address registration system according to claim 10, wherein

when the mobile management device receives the individual registration messages, the second means causes the mobile management device to register the source address as having been verified through ingress filtering of a network and send the response message to the source address to authorize the bulk registration, and

when the mobile node sends the bulk registration message, the third means causes the mobile node to use, as a source, an interface other than the address for which the bulk registration is authorized to send the bulk registration message including the source address, for which the bulk registration is authorized, somewhere other than the source address field.

(2) The address registration system according to claim 10 or (1) noted above, wherein

the second means causes the mobile management device to notify the mobile node of a bulk registration valid period through the response message, and

the third means causes the mobile node to send the bulk registration message within the bulk registration valid period.

(3) The address registration system according to claim 10 or either of (1) and (2) noted above, wherein

the first means causes the mobile node to request the mobile management device to authorize bulk registration through the individual registration messages using, as a source address, an address for which the bulk registration is desired, and

the third means causes the mobile node to send the mobile management device a bulk registration message including the address, for which the bulk registration is authorized, somewhere other than the source address field.

(4) The address registration system according to claim 10, wherein

the second means causes the mobile management device to notify the mobile node of a proxy node through the response message, and

the third means causes the mobile node to send the bulk registration message to the proxy node notified by the response message, and the proxy node to affix a signature to the bulk registration message and send the bulk registration message to the mobile management device.

(5) The address registration system according to claim 10, wherein when the mobile management device receives the individual registration messages, the second means causes the mobile management device to decide whether to authorize the bulk registration depending on the network to which an interface having the source address is connected.

(6) The address registration system according to claim 10, wherein

when the mobile management device receives the plurality of individual registration messages, the second means causes the mobile management device to register the source address and to notify the mobile node of bulk registration valid periods of individual source addresses, and

the third means causes the mobile node to change the source address between the individual source addresses according to the bulk registration valid periods of the individual source addresses in order to send the bulk registration message to the mobile management device.

(7) The address registration system according to claim 10 or any one of (1) to (6) noted above, wherein the second means causes the mobile management device to send a bulk registration acknowledgment message to acknowledge in bulk registration of respective source addresses of the plurality of individual registration messages as the response message for authorizing the bulk registration to any of the plurality of interfaces of the mobile node.

(8) The address registration system according to claim 10 or any one of (1), (2), (4), (5) and (7) noted above, wherein the second means causes the mobile management device to instruct the mobile node on an interface, from which the bulk registration message is to be sent, through the response message for authorizing the bulk registration.

(9) The mobile management device according to claim 17, wherein when receiving the individual registration messages, the mobile management device registers the source address as having been verified through ingress filtering of a network, and sends a response message to the source address to authorize the bulk registration.

(10) The mobile management device according to claim 17 or (9) noted above, wherein the mobile management device notifies the mobile node of a bulk registration valid period through the response message.

(11) The mobile management device according to claim 17 or (9) noted above, wherein the mobile management device notifies the mobile node of a proxy node, to which the mobile node sends the bulk registration message, through the response message.

(12) The mobile management device according to claim 17, wherein when receiving the individual registration messages, the mobile management device decides whether to authorize the bulk registration depending on the network to which an interface having the source address is connected.

(13) The mobile management device according to claim 17, wherein when receiving the plurality of individual registration messages, the mobile management device registers the source address and notifies the mobile node of bulk registration valid periods of individual source addresses.

(14) The mobile management device according to claim 17 or any one of (9) to (13) noted above, wherein the mobile management device sends a bulk registration acknowledgment message to acknowledge the bulk registration of respective source addresses of the plurality of individual registration messages as the response message for authorizing the bulk registration to any of the plurality of interfaces of the mobile node.

(15) The mobile management device according to claim 17 or any one of (9) to (14) noted above, wherein the mobile management device instructs the mobile node on an interface, from which the bulk registration message is to be sent, through the response message for authorizing the bulk registration.

### INDUSTRIAL APPLICABILITY

When each of the addresses associated with the multiple interfaces of the mobile node is registered with the mobile management device for managing the movement of the mobile node, the present invention has the advantage of being able to prevent a delay in transmission of packets destined to addresses other than the source address of the bulk registration message. The present invention can be used for SAE (System Architecture Evolution) being worked in 3GPP-LTE (Third Generation Partnership Project Long Term Evolution) project or the like.

1. An address registration method for registering, with a mobile management device for a mobile node, a plurality of addresses allocated to a plurality of interfaces of the mobile node, the method comprising:
a first step in which the mobile node sends the mobile management device a plurality of individual registration messages for registering a source address individually while setting each of addresses associated with the plurality of interfaces as the source address;
a second step in which, when receiving the plurality of individual registration messages, the mobile management device registers the source address and sends the mobile node a response message to authorize bulk registration for updating the plurality of addresses in bulk; and
a third step in which, when the plurality of addresses are updated in bulk after receiving the response message, the mobile node uses one of the plurality of interfaces as a source to send the mobile management device a bulk registration message including addresses of the other interfaces somewhere other than a source address field.

2. The address registration method according to claim 1, wherein
in the second step, when receiving the individual registration messages, the mobile management device registers the source address as having been verified through ingress filtering of a network, and sends a response message to the source address to authorize the bulk registration, and
in the third step, when sending the bulk registration message, the mobile node uses, as a source, an interface other than the address for which the bulk registration is authorized to send the bulk registration message including the address, for which the bulk registration is authorized, somewhere other than the source address field.

3. The address registration method according to claim 1, wherein
in the second step, the mobile management device notifies the mobile node of a bulk registration valid period through the response message, and
in the third step, the mobile node sends the bulk registration message within the bulk registration valid period.

4. The address registration method according to claim 1, wherein
in the first step, the mobile node requests the mobile management device to authorize bulk registration through the individual registration messages using, as the source address, an address for which the bulk registration is desired, and
in the third step, the mobile node sends the mobile management device a bulk registration message including the address, for which the bulk registration is authorized, somewhere other than the source address field.

5. The address registration method according to claim 1, wherein
in the second step, the mobile management device notifies the mobile node of a proxy node through the response message, and
in the third step, the mobile node sends the bulk registration message to the proxy node notified through the response message, and the proxy node affixes a signature to the bulk registration message and sends the bulk registration message to the mobile management device.

6. The address registration method according to claim 1, wherein
in the second step, when receiving the individual registration messages, the mobile management device decides whether to authorize the bulk registration depending on the network to which an interface having the source address is connected.

7. The address registration method according to claim 1, wherein
in the second step, when receiving the plurality of individual registration messages, the mobile management device registers the source address and notifies the mobile node of bulk registration valid periods of individual source addresses, and
in the third step, the mobile node changes the source address between the individual source addresses according to the bulk registration valid periods of the individual source addresses to send the bulk registration message.

8. The address registration method according to claim 1, wherein
in the second step, a bulk registration acknowledgment message to acknowledge the registration of respective source addresses of the plurality of individual registration messages in bulk is sent as the response message for authorizing the bulk registration to any of the plurality of interfaces of the mobile node.

9. The address registration method according to claim 1, wherein
in the second step, the mobile management device instructs the mobile node on an interface, from which the bulk registration message is to be sent, through the response message for authorizing the bulk registration.

10. An address registration system for registering, with a mobile management device for a mobile node, a plurality of addresses allocated to a plurality of interfaces of the mobile node, the system comprising:
first means for causing the mobile node to send the mobile management device a plurality of individual registration messages for registering a source address individually while setting each of addresses associated with the plurality of interfaces as the source address;
second means which, when the mobile management device receives the plurality of individual registration messages, causes the mobile management device to register the source address and send the mobile node a response message to authorize bulk registration for updating the plurality of addresses in bulk; and
third means which, when the plurality of addresses are updated in bulk after the mobile node receives the response message, causes the mobile node to use one of the plurality of interfaces as a source to send the mobile management device a bulk registration message including addresses of the other interfaces somewhere other than a source address field.

11. A mobile node in an address registration system for registering, with a mobile management device for the mobile node, a plurality of addresses allocated to a plurality of interfaces of the mobile node, the device comprising:
means for sending the mobile management device a plurality of individual registration messages to register a source address individually while setting each of addresses associated with the plurality of interfaces as the source address; and
means which, when the plurality of addresses are updated in bulk after receiving, from the mobile management device, a response message to authorize bulk registration for updating the plurality of addresses in bulk, uses one of the plurality of interfaces as a source to send the mobile management device a bulk registration message including addresses of the other interfaces somewhere other than a source address field.

12. The mobile node according to claim 11, wherein
when sending the bulk registration message, the mobile node uses, as a source address, an interface other than the source address for which the bulk registration is authorized to send the bulk registration message including the source address, for which the bulk registration is authorized, somewhere other than the source address field.

13. The mobile node according to claim 11, wherein
the mobile node sends the bulk registration message within a bulk registration valid period notified from the mobile management device through the response message.

14. The mobile node according to claim 11, wherein
the mobile node requests the mobile management device to authorize bulk registration through the individual registration messages using, as the source address, an address for which the bulk registration is desired, and
the mobile node sends the mobile management device a bulk registration message including the address, for which the bulk registration is authorized, somewhere other than the source address field.

15. The mobile node according to claim 11, wherein
the mobile node sends the bulk registration message to a proxy node notified through the response message.

16. The mobile node according to claim 11, wherein
the mobile node changes the source address between individual source addresses according to bulk registration valid periods of the individual source addresses to send the bulk registration message to the mobile management device.

17. A mobile management device in an address registration system for registering, with the mobile management device for a mobile node, a plurality of addresses allocated to a plurality of interfaces of the mobile node, the device comprising:
means which, when receiving, from the mobile node, a plurality of individual registration messages for registering a source address individually while setting each of addresses associated with the plurality of interfaces as the source address, registers the source address and sends the mobile node a response message to authorize bulk registration for updating the plurality of addresses in bulk; and
means which, after sending the response message, when receiving, from the mobile node using one of the plurality of interfaces as a source, a bulk registration message including addresses of the other interfaces somewhere other than a source address field, updates the plurality of addresses in bulk.
